(19) United States
(12) Patent Application Publication
(10) Pub. No.: US 2023/0084764 A1
(43) Pub. Date: Mar. 16, 2023

(54) ADHESIVE TAPE AND METHODS OF MAKING

(71) Applicant: 3M INNOVATIVE PROPERTIES COMPANY, St. Paul, MN (US)

(72) Inventors: Michele A. Craton, Cottage Grove, MN (US); Kelly J. Mathias, Woodbury, MN (US); Thomas Q. Chastek, St. Paul, MN (US); Robert D. Waid, Maplewood, MN (US); Ross J. DeVolder, Woodbury, MN (US)

(21) Appl. No.: 17/757,893

(22) PCT Filed: Dec. 16, 2020
(86) PCT No.: PCT/IB2020/062066

§ 371 Date: Jun. 23, 2022

Related U.S. Application Data
(60) Provisional application No. 62/952,569, filed on Dec. 23, 2019.

(51) Int. Cl. C09J 7/38; C09J 11/08

(52) U.S. Cl. CPC C09J 7/387; C09J 11/08; C09J 2301/416; C09J 2400/24; C09J 2453/00

(57) ABSTRACT

Tape constructions having a pressure sensitive adhesive containing a block copolymer component that includes a midblock segment and a plurality of end block segments, each end block segment comprising polystyrene, a (meth)acrylic functional additive having a glass transition temperature of from 50° C. to 160° C., a first tackifier compatible with the midblock segment and containing a hydrocarbon, and a second tackifier compatible with the end block segments and containing a polyphenylene ether that can be incorporated into articles. The pressure sensitive adhesive is subjected to electron beam radiation.

### FIELD OF THE INVENTION

Described herein are adhesive tapes and methods of making and using the same.

### BACKGROUND

Pressure-sensitive adhesives (“PSAs”) are adhesives that are normally tacky at room temperature and can be adhered to a substrate surface by application of light pressure. No solvent, water, or heat is needed to activate the adhesive.

Characteristics of pressure-sensitive adhesives are described in the Encyclopedia of Polymer Science and Engineering, Vol. 13, Wiley-Interscience Publishers (New York, 1988) and Encyclopedia of Polymer Science and Technology, Vol. 1, Interscience Publishers (New York, 1964). Conventionally, a pressure-sensitive adhesive meets the Dahlquist criterion described in DONATAS SATAS, HANDBOOK OF PRESSURE-SENSITIVE ADHESIVE TECHNOLOGY, 2^{nd} ed., p. 172 (1989). This criterion defines a pressure-sensitive adhesive as one having a one-second creep compliance of greater than 1×10⁻⁶ cm²/dyne at its service temperature (for example, at temperatures in a range of from 15° C. to 35° C.).

Pressure-sensitive adhesives can be prepared by compounding an elastomer and a suitable tackifier, such as a rosin ester, aliphatic or aromatic hydrocarbon, or terpene resin. Known elastomers include styrenic block copolymers, which include a polymerized glassy styrene block and a polymerized rubbery block (e.g., polyisoprene). At ambient temperatures, the styrenic block and the rubbery block microphase separate into discrete but connected domains to produce an elastomeric structure that is thermally reversible. Radial styrenic block copolymers are a subset of styrenic block copolymers where the elastomer has a multi-arm, rather than a linear structure.

The addition of a tackifier can convert a styrenic block copolymer from an elastic material into a viscoelastic material. A given tackifier can be compatible (i.e., miscible) with the glassy block, the rubbery block, or at least partially compatible with both types of blocks. Selective compatibility enables a given tackifier, when added to a styrenic block copolymer, to modify the properties of either the rubbery or glassy domains of the microphase separated structure.

### SUMMARY

One drawback of using a microphase separated block copolymer in pressure-sensitive adhesives is its susceptibility to loss of shear resistance at high temperatures. The maximum service temperature of these adhesives can be extended by increasing the softening temperature of the glassy block. This can be accomplished by adding an end block tackifier that increases the glass transition temperature of the styrene domains, while having a minimal effect on the glass transition temperature of the rubbery domains. As described in International Patent Publication No. WO00/24840 (Kobe, et al.), polyphenylene ether (PPE) oligomers can be used as such an end block tackifier to increase the temperature resistance of styrenic block copolymer PSAs.

The need remains, however, for a pressure-sensitive adhesive that is able to provide adhesion to a substrate over broad temperature range. The adhesive bond ideally resists high temperatures of 70 degrees Celsius or even 105 degrees Celsius and is able to quickly bond even at a low temperature of 5 degrees Celsius. This temperature compatibility may be particularly useful for tapes used to bond assemblies that are exposed to both high and low temperatures during assembly or use, as may be found in varying applications including, but not limited to, displays, more specifically, automotive displays, and other applications, such those as those for automobiles, handheld electronic devices, appliances, aerospace, and rail.

It has been discovered that a block copolymer-based pressure sensitive adhesive with PPE end block tackifiers can be modified with the addition of a low molecular weight, high-T_{g} oligomeric acrylate tackifier (HTG) and chemically crosslinked with electron beam radiation to improve the very high temperature performance of the adhesive bond, as measured in both Static Shear Adhesion to Polycarbonate Test at 70 and 105 degrees Celsius and Static T-Block Tensile Adhesion to Polycarbonate Test at 105 degrees Celsius. The modification maintains good cold tack as measured by Initial Cold Peel Adhesion to Polycarbonate Test at 5 degrees Celsius. The modification produces a tape in some embodiments with broad temperature performance, even at relatively lower electron beam radiation doses. A lower electron beam radiation does is advantageous for minimizing damage to other components in the tape construction such as liners or backings. Lower electron beam doses also enable lower cost manufacturing through lower equipment investment or higher production efficiencies.

In one aspect, a pressure sensitive adhesive tape with pressure sensitive adhesive layer is described herein, comprising: a block copolymer component comprising a midblock segment and a plurality of end block segments, each end block segment comprising polystyrene; a (meth)acrylic functional additive having a glass transition temperature of from 50° C. to 160° C.; a first tackifier compatible with the midblock segment and comprising a hydrocarbon; and a second tackifier compatible with the end block segments and comprising a polyphenylene ether; where the pressure sensitive adhesive layer is chemically crosslinked with electron beam radiation.

In a second aspect, a pressure sensitive adhesive tape as described, further comprising a flexible backing disposed adjacent the first major surface of the pressure sensitive adhesive layer. The flexible backing can be made from any known material suitable for tape backings.

In a third aspect, a pressure sensitive adhesive tape as described, further comprising a flexible backing disposed adjacent the first major surface of the pressure sensitive adhesive layer, wherein the flexible backing comprises a plurality of layers.

In a fourth aspect, a pressure sensitive adhesive tape as described, further comprising a flexible backing disposed adjacent the first major surface of the pressure sensitive adhesive layer, where the flexible backing could comprise a plurality of layers, and further comprising a release liner disposed adjacent the second major surface of pressure sensitive adhesive layer.

In a fourth aspect, a pressure sensitive adhesive tape as described, further comprising a flexible backing disposed adjacent the first major surface of the pressure sensitive adhesive layer, where the flexible backing could comprise a plurality of layers, and further comprise a release liner disposed adjacent the second major surface of pressure sensitive adhesive layer, and wherein the pressure sensitive layer is disposed on the release liner.

In a fifth aspect, a method of making the pressure sensitive adhesive tape is provided.

### BRIEF DESCRIPTION OF THE DRAWINGS

FIG. 1 illustrates a side profile view of a pressure sensitive adhesive-backed tape.

FIG. 2 illustrates a side profile view of a pressure sensitive adhesive-backed tape and flexible backing.

FIG. 3 illustrates a side profile view of a pressure sensitive adhesive-backed tape with flexible backing and release liner.

Repeated use of reference characters in the specification and drawings is intended to represent the same or analogous features or elements of the disclosure. Numerous other modifications and embodiments can be devised by those skilled in the art, which fall within the scope and spirit of the principles of the disclosure. Figures may not be drawn to scale.

### Definitions

As used herein:

“ambient temperature” means at a temperature of 25° C.;

“amino” refers to a chemical group containing a basic nitrogen atom with a lone pair (—NHR), and may be either a primary or secondary chemical group;

“average” generally refers to a number average but may, when referring to particle diameter, either represent a number average or volume average;

“compatible with” means miscible with or soluble with;

“cure” refers to exposing to radiation in any form, heating, or allowing to undergo a physical or chemical reaction that results in hardening or an increase in viscosity;

“curing onset temperature” refers to the temperature above which a given curative in a curable composition induces curing in the curable composition, as measured by differential scanning calorimetry at a scan rate of +10° C. per minute;

“fully cure” refers to curing to an extent sufficient for the cured material to be used in its intended application;

“halogen” group refers to a fluorine, chlorine, bromine, iodine, or astatine atom, unless otherwise stated;

“hydrocarbon” refers to a molecule or functional group that includes carbon and hydrogen atoms;

“partially cure” means curing to an extent that is measurable but insufficient for the cured material to be used in its intended application;

“particle diameter” represents the largest transverse dimension of the particle;

“polymer” refers to a molecule having at least one repeating unit and can include copolymers; and

“substituted” as used herein in conjunction with a molecule or an organic group as defined herein refers to the state in which one or more hydrogen atoms contained therein are replaced by one or more non-hydrogen atoms.

### DETAILED DESCRIPTION

Reference will now be made to various embodiments of the disclosed subject matter. While the disclosed subject matter will be described in conjunction with the enumerated claims, it will be understood that the exemplified subject matter is not intended to limit the claims to the disclosed subject matter.

The terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for description only and not of limitation. Any use of section headings is intended to aid reading of the document and is not to be interpreted as limiting; information that is relevant to a section heading may occur within or outside of that section.

The present disclosure provides pressure sensitive adhesive compositions, foam compositions, pressure sensitive adhesive tapes that contain the pressure-sensitive adhesive compositions and foam compositions, along with methods of making such pressure sensitive adhesive tapes and pressure sensitive adhesive foam tapes. Such pressure sensitive adhesive compositions can be suitable for use, for example, in pressure-sensitive adhesive tapes.

The pressure sensitive adhesive compositions may be suitable for use in pressure sensitive adhesive tapes and pressure sensitive adhesive foam tapes, including tapes with and without a backing. Pressure sensitive adhesive tapes and pressure sensitive adhesive foam tapes may be single-sided or double-sided. They may be transfer tapes (adhesive strip without a backing, delivered on a release liner). The pressure sensitive adhesive compositions as embodied in tapes are present as layers of generally uniform thickness.

The pressure sensitive adhesive compositions can be melt processed by heating the pressure sensitive adhesive composition to high temperatures and then cooling to provide a pressure sensitive adhesive.

The provided pressure sensitive adhesive compositions can in some embodiments contain zero or only trace amounts of volatile organic solvents. In a preferred embodiment, the pressure sensitive adhesive composition does not require use of any volatile organic solvent in bonding to a substrate.

In general, the pressure sensitive adhesive compositions described herein include a block copolymer having rubbery and glassy segments mixed with a (meth)acrylic functional additive. The pressure sensitive adhesive composition further includes two distinct tackifiers, the first tackifier based on a hydrocarbon compatible with the midblock segment and the second tackifier based on a polyphenylene ether compatible with the end block segments.

In general, the pressure sensitive adhesive compositions described herein, after being processed and formed into a pressure sensitive adhesive tape, are chemically crosslinked with electron beam radiation.

Details concerning the provided pressure sensitive adhesive compositions can be found in the subsections below.

### Block Copolymer Component

The provided pressure sensitive adhesive compositions contain a block copolymer component. The block copolymer component can be a single block copolymer or a mixture of two or more block copolymers. At least one block copolymer in the block copolymer component is a styrenic block copolymer including a rubbery block (or low-T_{g} block) and two or more glassy blocks (or high-T_{g} blocks).

At the service temperature of the pressure sensitive adhesive, the block copolymer component microphase separates into ordered nanoscale domains that include rubbery block domains and glassy block domains. This ordered structure provides the block copolymer component with useful and unique physical properties. When microphase separated, these copolymers form elastic, dimensionally stable solids that display significant shear strength. Unlike crosslinked rubbers, their materials are capable of being reversibly melted and re-solidified with temperature.

A block copolymer-based pressure sensitive adhesive with PPE end block tackifiers can be modified with the addition of a low molecular weight, high-T_{g} oligomeric acrylate tackifier (HTG) and chemically crosslinked with electron beam radiation to improve the very high temperature performance of the adhesive bond, as measured in both Static Shear Adhesion to Polycarbonate Test at 70 and 105 degrees Celsius and Static T-Block Tensile Adhesion to Polycarbonate Test at 105 degrees Celsius. The modification maintains good cold tack as measured by Initial Cold Peel Adhesion to Polycarbonate Test at 5 degrees Celsius. The modification enables achieving a pressure sensitive adhesive tape or pressure sensitive adhesive foam tape with broad temperature performance at lower electron beam radiation doses, the lower electron beam doses being advantageous for minimizing damage to other components in the tape construction such as liners or backings. Lower electron beam doses also enable lower cost manufacturing through lower equipment investment or higher production efficiencies.

The styrenic block copolymer is often a linear block copolymer of general formula (G-R)ₘ-G where G is a glassy block, R is a rubbery block, and m is an integer equal to at least 1. Variable m can be from 1 to 10, 1 to 5, 1 to 3, or in some embodiments, less than, equal to, or greater than 1, 2, 3, 4, 5, 6, 7, 8, 9, or 10. In a preferred embodiment, the linear block copolymer is a triblock copolymer of formula G-R-G where the variable m in the formula (G-R)ₘ-G is equal to 1.

Alternatively, the styrenic block copolymer can be a star (also known as a radial or multi-arm) block copolymer of general formula (G-R)ₙ-Y where each R and G are the same as defined above, n is an integer equal to at least 3, and Y is the residue of a multifunctional coupling agent used in the formation of the star block copolymer. The variable n represents the number of arms in the star block copolymer and can be from 3 to 10, from 3 to 8, from 3 to 6, or in some embodiments, less than, equal to, or greater than 3, 4, 5, 6, 7, 8, 9, or 10.

In both the linear block copolymer and star block copolymer versions of the styrenic block copolymer, the glassy blocks can have the same or different molecular weight. Similarly, if there is more than one rubbery block, the rubbery blocks can have the same or different molecular weights.

Generally, each rubbery block has a glass transition temperature (T_{g}) that is less than ambient temperature. For example, the glass transition temperature can be less than 20° C., less than 0° C., less than −10° C., or less than −20° C., less than −40° C., less than −60° C., or in some embodiments, less than, equal to, or greater than −60° C., −55, −50, −45, −40, −35, −30, −25, −20, −15, −10, −5, 0, 5, 10, 15, or 20° C. The glass transition temperature can be determined using conventional methods known in the art, including Differential Scanning calorimetry or Dynamic Mechanical Analysis.

Each rubbery block in the linear or star block copolymers is typically the polymerized product of a first polymerized conjugated diene, a hydrogenated derivative of a polymerized conjugated diene, or a combination thereof. The conjugated diene often contains 4 to 12 carbon atoms. Conjugated dienes include, but are not limited to, butadiene, isoprene, 2-ethylbutadiene, 1-phenylbutadiene, 1,3-pentadiene, 1,3-hexadiene, 2,3-dimethyl-1,3-butadiene, and 3-ethyl-1,3-hexadiene.

Each rubbery block can be a homopolymer or copolymer. The rubbery block is often poly(butadiene), poly(isoprene), poly(2-ethylbutadiene), poly(l-phenylbutadiene), poly(1,3-pentadiene), poly(1,3-hexadiene), poly(2,3-dimethyl-1,3-butadiene), poly(3-ethyl-1,3-hexadiene), poly(ethylene/propylene), poly(ethylene/butylene), poly(isoprene/butadiene), or the like. In many embodiments, the block R is polybutadiene, polyisoprene, poly(isoprene/butadiene), poly(ethylene/butylene), or poly(ethylene/propylene).

The glass transition temperature of each glassy block is generally at least 50° C., at least 60° C., at least 70° C., at least 80° C., at least 90° C., at least 100° C., or in some embodiments, less than, equal to, or greater than 50° C., 55, 60, 65, 70, 75, 80, 85, 90, 95, or 100° C. Each glassy block in the linear or star block copolymers is typically the polymerized product of a mono-vinyl aromatic monomer. The mono-vinyl aromatic monomer usually contains, for example, at least 8 carbon atoms, at least 10 carbon atoms, or at least 12 carbon atoms and up to 18 carbon atoms, up to 16 carbon atoms, or up to 14 carbon atoms. Example first mono-vinyl aromatic monomers include, but are not limited to, styrene, vinyl toluene, alpha-methyl styrene, 2,4-dimethyl styrene, ethyl styrene, 2,4-diethyl styrene, 3,5-diethyl styrene, alpha-2-methyl styrene, 4-tert-butyl styrene, 4-isopropyl styrene, and the like.

Each glassy block can be a homopolymer or a copolymer. The glassy block can be poly(styrene), poly(vinyl toluene), poly(alpha-methyl styrene), poly(2,4-dimethyl styrene), poly(ethyl styrene), poly(2,4-diethyl styrene), poly(3,5-diethyl styrene), poly(alpha-2-methyl styrene), poly(4-tert-butyl styrene), poly(4-isopropyl styrene), copolymers thereof, and the like.

In some embodiments, the glassy block is polystyrene homopolymer or is a copolymer derived from a mixture of styrene and a styrene-compatible monomer, which is a monomer that is miscible with styrene. In most cases where the glassy phase is a copolymer, at least 50 weight percent of the monomeric units are derived from styrene. For example, at least 60 weight percent, at least 70 weight percent, at least 80 weight percent, at least 90 weight percent, at least 95 weight percent, at least 98 weight percent, or at least 99 weight percent of the monomeric units in the glassy block is derived from styrene.

The glassy blocks can represent from 5 to 50 percent by weight of the styrenic block copolymer. If the fraction of glassy blocks is too low, the cohesive strength may be too low. On the other hand, if the fraction of glassy blocks is too high, the modulus may be too high (i.e., the composition may be too stiff and/or too elastic) and the resulting composition will not effectively wet out on a substrate surface. The styrenic copolymer can have a styrene (or glassy block) content of from 7% to 40%, 9% to 33%, 13% to 25%, or in some embodiments, less than, equal to, or greater than 7%, 8, 9, 10, 11, 12, 13, 14, 15, 16, 17, 18, 19, 20, 21, 22, 23, 24, 25, 27, 30, 32, 35, 37, or 40%, relative to the overall weight of the styrenic block copolymer.

In addition to the glassy blocks and the rubbery blocks, styrenic block copolymers that are star block copolymers include a multifunctional coupling agent J. The coupling agent often has multiple carbon-carbon double bonds, carbon-carbon triple bonds, or other groups that can react with carbanions of the living polymer used to form the star block copolymers. The multifunctional coupling agents can be aliphatic, aromatic, heterocyclic, or a combination thereof. Example include, but are not limited to, polyvinyl acetylene, diacetylene, di(meth)acrylates (e.g., ethylene dimethacrylate), divinyl benzene, divinyl pyridine, and divinyl thiophene. Other examples include, but are not limited to, multi-functional silyl halide (e.g., tetrafunctional silyl halide), polyepoxides, polyisocyanates, polyketones, polyanhydrides, polyalkenyls, and dicarboxylic acid esters.

The weight average molecular weight of a styrenic block copolymer is often no greater than 1,200,000 g/mol. If the weight average molecular weight is too high, the copolymer will be difficult to use in preparation of a pressure sensitive adhesive composition. That is, high concentrations of organic solvent would be needed for solution coating. If melt processed, the copolymer would be difficult to extrude due to its high melt viscosity and would be difficult to blend with other materials. By contrast, a molecular weight that is too low can result in a pressure sensitive adhesive layer with a cohesive strength that is unacceptably low.

The weight average molecular weight is often no greater than 1,000,000 g/mol, no greater than 900,000 g/mol, no greater than 800,000 g/mol, no greater than 600,000 g/mol, or no greater than 500,000 g/mol. The weight average molecular weight of the styrenic block copolymer is typically at least 75,000 g/mol, at least 100,000 g/mol, at least 200,000 g/mol, at least 300,000 g/mol, or at least 400,000 g/mol.

The weight average molecular weight of the styrenic block copolymer can be from 75,000 g/mol to 1,200,000 g/mol, from 100,000 to 1,000,000 g/mol, from 100,000 to 900,000 g/mol, from 100,000 to 500,000 g/mol, or in some embodiments, less than, equal to, or greater than 75,000 g/mol; 80,000; 85,000; 90,000; 95,000; 100,000; 110,000; 120,000; 130,000; 140,000; 150,000; 160,000; 170,000; 180,000; 190,000; 200,000; 220,000; 240,000; 250,000; 260,000; 280,000; 300,000; 350,000; 400,000; 450,000; 500,000; 600,000; 700,000; 750,000; 800,000; 900,000; 1,000,000; or 1,200,000 g/mol.

Some styrenic block copolymers have glassy blocks that are polystyrene and one or more rubbery blocks selected from polyisoprene, polybutadiene, poly(isoprene/butadiene), poly(ethylene/butylene), and poly(ethylene/propylene). Some even more particular styrenic block copolymers have glassy blocks that are polystyrene and one or more rubbery blocks selected from polyisoprene and polybutadiene.

In some embodiments, the styrenic block copolymer is a first styrenic block copolymer, and the block copolymer components further includes a second styrenic block copolymer that is a diblock copolymer. The diblock copolymer generally has a single glassy block and a single rubbery block, and can be represented here by the chemical structure G-R.

Inclusion of a diblock copolymer can lower the viscosity of the pressure-sensitive adhesive and/or provide functionality akin to that obtained when adding a plasticizer. In some embodiments, the diblock copolymer can increase the tackiness and low temperature performance of the resulting pressure sensitive adhesive composition. The diblock copolymer also can be used to adjust the flow of the pressure sensitive adhesive. The amount of diblock can be selected to provide the desired flow characteristics without significantly impacting the cohesive strength of the pressure sensitive adhesive.

The same glassy blocks and rubbery blocks described with respect to the first styrenic block copolymer (e.g., triblock and star block copolymers) are applicable when describing the second styrenic block copolymer (i.e., the diblock copolymer).

The styrene content in the diblock copolymer can be from 10% to 50%, from 10% to 40%, from 15% to 50%, from 15% to 40%, from 20% to 50%, from 20% to 40%, or in some embodiments, less than, equal to, or greater than 10%, 12, 15, 17, 20, 22, 25, 27, 30, 32, 35, 37, or 40% by weight relative to the overall weight of the diblock copolymer.

The weight average molecular weight of the diblock copolymer can be from 75,000 to 250,000 g/mol, from 100,000 to 250,000 g/mol, from 125,000 to 250,000 g/mol, from 125,000 to 200,000 g/mol, or in some embodiments, less than, equal to, or greater than 75,000 g/mol; 80,000; 85,000; 90,000; 95,000; 100,000; 110,000; 120,000; 130,000; 140,000; 150,000; 160,000; 170,000; 180,000; 190,000; 200,000; 220,000; 240,000; or 250,000 g/mol.

The styrenic component can represent 1 to 30 weight percent of the diblock copolymer based on a total weight of the diblock copolymer. In some embodiments, the diblock copolymer is present in an amount of from 1% to 25%, from 3% to 15%, from 5% to 10%, or in some embodiments, less than, equal to, or greater than 1%, 2, 3, 4, 5, 7, 10, 12, 15, 17, 20, 22, or 25% by weight relative to the overall weight of the second styrenic block copolymer.

In some embodiments, the styrenic component contains 70% to 100% by weight of a star block copolymer and/or linear block copolymer (e.g., linear triblock copolymer) and 0% to 30% by weight of a diblock copolymer, 70% to 99% by weight of a star block copolymer and/or linear block copolymer and 1% to 30% by weight of a diblock copolymer, 70% to 90% by weight of a star block copolymer and/or linear block copolymer and 10% to 30% by weight of a diblock copolymer, 75% to 100% by weight of a star block copolymer and/or linear block copolymer and 0% to 25% by weight of a diblock copolymer, 75% to 99% by weight of a star block copolymer and/or linear block copolymer and 1% to 25% by weight of a diblock copolymer, 75% to 90% by weight of a star block copolymer and/or linear block copolymer and 10% to 25% by weight of a diblock copolymer, 80% to 100% by weight of a star block copolymer and/or linear block copolymer and 0% to 20% by weight of a diblock copolymer, 80% to 99% by weight of a star block copolymer and/or linear block copolymer and 1% to 20% by weight of a diblock copolymer, or 80% to 90% by weight of a star block copolymer and/or linear block copolymer and 10% to 20% by weight of a diblock copolymer.

In many embodiments, the styrenic component contains 70% to 100% by weight of a linear triblock copolymer and 0% to 30% percent by weight of a diblock copolymer, 70% to 99% by weight of a linear triblock copolymer and 1% to 30% by weight of a diblock copolymer, 70% to 95% by weight of a linear triblock copolymer and 5% to 30% by weight of a diblock copolymer, or 70% to 90% by weight of a triblock copolymer and 10% to 30% by weight of a diblock copolymer.

The block copolymer component can be present in any suitable amount in the adhesive composition. For example, the block copolymer component is present in amount of from 30% to 65%, from 35% to 60%, from 45% to 55%, or in some embodiments, less than, equal to, or greater than 30%, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, or 65% by weight relative to the overall weight of the composition.

Suitable materials for use as the styrenic component alone or in combination are commercially available under the trade designation KRATON (e.g., KRATON D1161P, D1118, D1119, and A1535) from Kraton Performance Polymers (Houston, Tex., USA), under the trade designation SOLPRENE (e.g., SOLPRENE S-1205) from Dynasol (Houston, Tex., USA), under the trade designation QUINTAC from Zeon Chemicals (Louisville, Ky., USA), and under the trade designations VECTOR and TAIPOL from TSRC Corporation (New Orleans, La., USA).

The pressure sensitive adhesive can contain from 30% to 60% by weight of the styrenic component based on the total weight of the pressure sensitive adhesive. If the amount of the styrenic component is too low, the tackifier level may be too high and the resulting T_{g} of the composition may be too high (e.g., the composition may not be a pressure sensitive adhesive), particularly in the absence of a plasticizer. If the amount of the styrenic component is too high, the composition may have a modulus that is too high (e.g., the composition may be too stiff and/or too elastic) and the composition may not properly wet out when applied to a substrate.

The amount of the styrenic component can be from 30% to 60%, 40% to 55%, 40% to 50%, 45% to 60%, 45% to 55%, 50% to 60%, or in some embodiments, less than, equal to, or greater than 30%, 31, 32, 33, 34, 35, 36, 37, 38, 39, 41, 42, 43, 44, 45, 46, 47, 48, 49, 50, 51, 52, 53, 54, 55, 56, 57, 58, 59, or 60% by weight relative to the total weight of the pressure-sensitive adhesive.

### First (Meth)Acrylic Functional Additive

The pressure sensitive adhesive composition contains a (meth)acrylic functional additive. The (meth)acrylic functional additive is generally non-polar but can contain small amounts of polar monomeric units as described below. This (meth)acrylic functional additive was found to provide the adhesive with high temperature holding power to low surface energy substrates. The additive can also impart a “primerless” feature to the adhesive, in which no primer or adhesion promoter is needed prior to making a bond with the provided adhesive composition.

The functional additive is comprised of a (meth)acrylic polymer or optionally a mixture of two or more (meth)acrylic polymers. The (meth)acrylic polymers, in each case, can be linear. Each (meth)acrylic polymer can be a random copolymer obtained by polymerizing a monomer mixture. In some embodiments, at least 60 weight percent, at least 70 weight percent, at least 80 weight percent, at least 90 weight percent, at least 95 weight percent, at least 98 weight percent, at least 99 weight percent, or 100 weight percent of the monomer mixture has a (meth)acryloyl group of formula —(CO)—CR═CH₂, where R is hydrogen or methyl group.

The (meth)acrylic functional additive has an overall glass transition temperature that is well above ambient temperature. The glass transition temperature can be from 60° C. to 160° C., from 75° C. to 120° C., from 80° C. to 105° C., or in some embodiments, less than, equal to, or greater than, 50° C., 55, 60, 65, 70, 75, 80, 85, 90, 95, 100, 105, 110, 115, 120, 125, 130, 135, 140, 145, 150, 155, or 160° C.

The (meth)acrylic functional additive can be the polymerization product of one or more known high-T_{g} monomers. Suitable high-T_{g} monomers include, but are not limited to, methyl methacrylate, ethyl methacrylate, n-propyl methacrylate, isopropyl methacrylate, isobutyl methacrylate, sec-butyl methacrylate, tert-butyl (meth)acrylate, phenyl (meth)acrylate, cyclohexyl (meth)acrylate, isobornyl (meth)acrylate, benzyl (meth)acrylate, 3,3,5 trimethylcyclohexyl (meth)acrylate, and mixtures thereof.

The one or more high-T_{g} monomers can be present in an amount of from 30% to 100%, 50% to 98%, 70% to 95%, or in some embodiments, less than, equal to, or greater than 30%, 32, 35, 37, 40, 42, 45, 47, 50, 52, 55, 57, 60, 62, 65, 67, 70, 72, 75, 77, 80, 82, 85, 87, 90, 92, 95, 97, 98, or 99%, or less than or equal to 100% by weight, relative to the overall weight of monomers in the monomer mixture used to synthesize the (meth)acrylic functional additive.

In addition to the high-T_{g} monomer, the monomer mixture can include an optional polar monomer, an optional low-T_{g} monomer, an optional vinyl monomer that does not include a (meth)acryloyl group, or a mixture thereof. These monomers can be provided in any suitable amount in the monomer mixture to provide polymerized functional additive characterized by an overall T_{g}. The overall T_{g} of the (meth)acrylic functional additive can be from 50° C. to 160° C., from 60° C. to 150° C., from 75° C. to 120° C., or in some embodiments, less than, equal to, or greater than 50° C., 55, 60, 65, 70, 75, 80, 85, 90, 95, 100, 105, 110, 115, 120, 125, 130, 135, 140, 145, 150, 155, or 160° C.

One or more optional low-T_{g} monomers are known in the art and can include any of the monomers described in the subsection below, entitled “Second (meth)acrylic functional additive.” Preferably, the low-T_{g} monomer, if present, is miscible with the high-T_{g} monomer(s) and any other components present in the (meth)acrylic functional additive. Including a low-T_{g} into the monomer mixture can be useful in adjusting the overall T_{g} of the final polymerized (meth)acrylic functional additive.

One or more polar monomers can be mixed into in the monomer mixture and polymerized to obtain the (meth)acrylic functional additive. Useful polar monomers can have an ethylenically unsaturated group plus a polar group such as an acidic group or a salt thereof, a hydroxyl group, a primary amido group, a secondary amido group, a tertiary amido group, or an amino group. Introducing a polar monomer into the functional additive can facilitate adhesion of the pressure-sensitive adhesive to certain substrates.

In some embodiments, the polar monomer is a polar (meth)acrylic monomer. The polar acrylic (meth)acrylic monomer can have an acidic group. Such monomers include ethylenically unsaturated carboxylic acids, ethylenically unsaturated sulfonic acids, ethylenically unsaturated phosphonic acids, and mixtures thereof. Specific examples include acrylic acid, methacrylic acid, itaconic acid, fumaric acid, crotonic acid, citraconic acid, maleic acid, oleic acid, β-carboxyethyl (meth)acrylate, 2-sulfoethyl methacrylate, styrene sulfonic acid, 2-acrylamido methylpropanesulfonic acid, and vinyl phosphonic acid.

Polar monomers containing a hydroxyl group include, for example, hydroxyalkyl (meth)acrylates (e.g., 2-hydroxyethyl (meth)acrylate, 2-hydroxypropyl (meth)acrylate, 3-hydroxypropyl (meth)acrylate, and 4-hydroxybutyl (meth)acrylate), hydroxyalkyl (meth)acrylamides (e.g., 2-hydroxyethyl (meth)acrylamide and 3-hydroxypropyl (meth)acrylamide), ethoxylated hydroxyethyl (meth)acrylate (e.g., monomers commercially available from Sartomer USA (Exton, Pa., USA) under the trade designation CD570, CD571, and CD572), and aryloxy substituted hydroxyalkyl (meth)acrylates (e.g., 2-hydroxy-2-phenoxypropyl (meth)acrylate).

Polar monomers containing a primary amido group include, for example, (meth)acrylamide. Polar monomers with secondary amido groups include, for example, N-alkyl (meth)acrylamides such as N-methyl (meth)acrylamide, N-ethyl (meth)acrylamide, N-isopropyl (meth)acrylamide, N-tert-octyl (meth)acrylamide, or N-octyl (meth)acrylamide.

Polar monomers containing a tertiary amido group include, for example, N-vinyl caprolactam, N-vinyl-2-pyrrolidone, (meth)acryloyl morpholine, and N,N-dialkyl (meth)acrylamides such as N,N-dimethyl (meth)acrylamide, N,N-diethyl (meth)acrylamide, N,N-dipropyl (meth)acrylamide, and N,N-dibutyl (meth)acrylamide.

Polar monomers with an amino group include various N,N-dialkylaminoalkyl (meth)acrylates and N,N-dialkylaminoalkyl (meth)acrylamides. Examples include N,N-dimethyl aminoethyl (meth)acrylate, N,N-dimethylaminoethyl (meth)acrylamide, N,N-dimethylaminopropyl (meth)acrylate, N,N-dimethylaminopropyl (meth)acrylamide, N,N-diethylaminoethyl (meth)acrylate, N,N-diethylaminoethyl (meth)acrylamide, N,N-diethylaminopropyl (meth)acrylate, and N,N-diethylaminopropyl (meth)acrylamide.

The amount of the optional polar monomer can be from 0.5% to 12%, from 2% to 10%, from 0.5% to 10%, from 3% to 8%, or in some embodiments, equal to or greater than 0%, or less than, equal to, or greater than 0.1%, 0.2, 0.3, 0.4, 0.5, 0.6, 0.7, 0.8, 0.9, 1, 1.1, 1.2, 1.3, 1.4, 1.5, 1.7, 2, 2.2, 2.5, 2.7, 3, 3.2, 3.5, 3.7, 4, 4.5, 5, 5.5, 6, 6.5, 7, 7.5, 8, 8.5, 9, 9.5, 10, 10.5, 11, 11.5, or 12% by weight relative to the overall weight of monomers in the monomer mixture used to polymerize the (meth)acrylic functional additive.

In some embodiments, the monomer mixture used to form the (meth)acrylic functional additive contains from 85% to 100% by weight high-T_{g} monomer and 0% to 15% by weight polar monomer. For example, the monomer mixture can contain 85% to 99.5% by weight high-T_{g} monomer and 0.5% to 15% by weight polar monomer, 85% to 99% by weight high-T_{g} monomer and 1% to 15% by weight polar monomer, or 90% to 99% by weight high-T_{g} monomer and 1% to 10% by weight polar monomer. For each of the ranges above, percentages are based on the total weight of monomers in the monomer mixture.

In some embodiments, the (meth)acrylic functional additive contains 85% to 100% by weight high-T_{g} monomers and 0% to 15% by weight polar monomers. For example, the (meth)acrylic functional additive can contain 85% to 99.5% by weight high-T_{g} monomers and 0.5% to 15% by weight polar monomers, 85% to 99% by weight high-T_{g} monomers and 1% to 15% by weight polar monomers, or 90% to 99% by weight high-T_{g} monomers and 1% to 10% by weight polar monomers, in each case based on the overall weight of monomeric units in the monomer mixture. As used herein, the term “monomeric unit” refers to the polymerized version of the monomer (i.e., the ethylenically unsaturated group of the monomer has undergone polymerization with other ethylenically unsaturated monomers).

Optionally one or more vinyl monomers are included in the monomer mixture that do not contain a (meth)acryloyl group. Examples of optional vinyl monomers include, but are not limited to, various vinyl ethers (e.g., vinyl methyl ether), vinyl esters (e.g., vinyl acetate and vinyl propionate), styrene, substituted styrene (e.g., α-methyl styrene), vinyl halide, and mixtures thereof. The vinyl monomers having a group characteristic of polar monomers are considered herein to be polar monomers.

Advantageously, the (meth)acrylic functional additives are generally linear polymers and are not crosslinked. The lack of crosslinking facilitates mixing and compatibility with the styrenic component of the pressure-sensitive adhesive.

In some embodiments, the monomer mixture contains 30% to 100% by weight high-T_{g} monomer, 0% to 15% by weight polar monomer, 0% to 50% by weight low-T_{g} monomer, and 0% to 15% by weight vinyl monomers that do not include a (meth)acryloyl group. In still other embodiments, the monomer mixture contains 60% to 100% by weight high-T_{g} monomer, 0% to 15% by weight polar monomer, 0% to 20% by weight low-T_{g} monomer, and 0% to 10% by weight vinyl monomers that do not include a (meth)acryloyl group. In yet other embodiments, the monomer mixture contains 75% to 100% by weight high-T_{g} monomer, 0% to 10% by weight polar monomer, 0% to 10% by weight low-T_{g} monomer, and 0% to 5% by weight vinyl monomers that do not include a (meth)acryloyl group. Similar compositional ranges apply to (meth)acrylic functional additives polymerized from the monomer mixtures described above.

In some embodiments, the (meth)acrylic functional additive contain up to 100 weight percent methyl methacrylate monomeric units. Optionally, the additive can contain a mixture of isobornyl (meth)acrylate monomeric units and a polar monomeric unit such as (meth)acrylic acid monomeric units or N,N-dimethylacrylamide monomeric units.

When the monomer mixture is polymerized, the resulting (meth)acrylic functional additive can have any suitable molecular weight. The (meth)acrylic functional additive can have a weight average molecular weight (M_{W}) of from 1,000 g/mol to 300,000 g/mol, from 10,000 g/mol to 75,000 g/mol, from 25,000 to 40,000 g/mol, or in some embodiments, less than, equal to, or greater than 1,000 g/mol; 2,000; 3,000, 4,000; 5,000; 6,000; 7,000; 8,000; 9,000; 10,000; 15,000; 20,000; 25,000; 30,000; 35,000; 40,000, 45,000; 50,000; 60,000; 70,000; 80,000; 90,000; 100,000; 120,000; 150,000; 170,000; 200,000; 220,000; 250,000; 270,000; or 300,000 g/mol.

Useful (meth)acrylic functional additives are commercially available under the trade designation ELVACITE (e.g., ELVACITE 2008C, E2013, E2043, and E4402) from Lucite International Inc. in Cordova, Tenn. The (meth)acrylic functional additive may also be prepared using any known synthetic method. Suitable methods include, for example, free radical polymerization methods, such as those described in co-pending International Patent Application No. IB2017/057845 (Chastek et al.).

The amount of the (meth)acrylic functional additive should be present in a suitable amount relative to the total weight of the pressure sensitive adhesive composition. If the amount is to low, the composition may not have sufficient holding power on a broad range of substrates (e.g., substrates having a variety of surface energy values), particularly at elevated temperatures. On the other hand, if the amount is too high, the pressure sensitive adhesive composition may have a glass transition temperature that is too high. That is, the overall pressure sensitive adhesive composition may be too glassy to function as a pressure-sensitive adhesive.

The amount of (meth)acrylic functional additive present in the pressure sensitive adhesive composition should be sufficient to have an effect but not so large that the additive phase separates from the remainder of the adhesive composition and degrades performance. It is typical for (meth)acrylic functional additive to be from 1% to 12%, from 2% to 8%, from 3% to 6%, or in some embodiments, less than, equal to, or greater than 1, 1.5, 2, 2.5, 3, 3.5, 4, 4.5, 5, 5.5, 6, 6.5, 7, 7.5, 8, 8.5, 9, 9.5, 10, 10.5, 11, 11.5, or 12% by weight relative to the total weight of the pressure sensitive adhesive composition.

### Second (Meth)Acrylic Functional Additive

The provided pressure sensitive adhesive compositions optionally contain a second (meth)acrylic functional additive. The second (meth)acrylic functional additive has a polarity that is high relative to that of the block copolymer component of the pressure sensitive adhesive composition. This polarity has been found to improve moisture tolerance of the adhesive when bonding to particular substrates. The second (meth)acrylic functional additive can be, in some embodiments, itself be a pressure-sensitive adhesive composition.

Applications in which moisture tolerance is beneficial include bonding to, for example, automotive clearcoat films, household paints such as latex paints, and hygroscopic substrates that tend to absorb moisture. In some embodiments, the polar nature of the second (meth)acrylic functional additive improves adhesion by wicking moisture away from the bond interface. This additive may not be needed for certain substrates but can broaden the range of suitable substrates for the provided pressure sensitive adhesive composition.

In various embodiments, the second (meth)acrylic functional additive is a random copolymer of a mixture of low-T_{g} monomers. The random copolymer can have an overall glass transition temperature that is well below ambient temperature. The glass transition temperature can be from −60° C. to 25° C., from −55° C. to 10° C., from −50° C. to 0° C., or in some embodiments, less than, equal to, or greater than −60° C., −55, −50, −45, −40, −35, −30, −25, −20, −15, −10, −5, 0, 5, 10, 15, 20, 25, 30, or 35° C. Suitable low-T_{g} monomers include certain alkyl (meth)acrylates, heteroalkyl (meth)acrylates, and aryl substituted alkyl acrylates and aryloxy substituted alkyl acrylates.

Useful low-T_{g} alkyl (meth)acrylate monomers include alkyl methacrylates having a linear alkyl group with at least 4 carbon atoms. Specific examples of alkyl (meth)acrylates include, but are not limited to, methyl acrylate, ethyl acrylate, n-propyl acrylate, n-butyl acrylate, n-butyl methacrylate, isobutyl acrylate, sec-butyl acrylate, n-pentyl acrylate, 2-methylbutyl acrylate, n-hexyl acrylate, cyclohexyl acrylate, 4-methyl-2-pentyl acrylate, 2-methylhexyl acrylate, 2-ethylhexyl acrylate, n-octyl acrylate, 2-octyl acrylate, isooctyl acrylate, isononyl acrylate, isoamyl acrylate, n-decyl acrylate, isodecyl acrylate, n-decyl methacrylate, lauryl acrylate, isotridecyl acrylate, n-octadecyl acrylate, isostearyl acrylate, and n-dodecyl methacrylate.

Low-T_{g} monomers also include heteroalkyl (meth)acrylate monomers having at least 3 carbon atoms, at least 4 carbon atoms, or at least 6 carbon atoms and up to 30 or more carbon atoms, up to 20 carbon atoms, up to 18 carbon atoms, up to 16 carbon atoms, up to 12 carbon atoms, or up to 10 carbon atoms. Specific heteroalkyl (meth)acrylates include, for example, 2-ethoxyethyl acrylate, 2-(2-ethoxyethoxy)ethyl acrylate, 2-methoxyethyl (meth)acrylate, and tetrahydrofurfuryl (meth)acrylate. Heteroalkyl (meth)acrylate monomers further include aryl substituted alkyl acrylates or aryloxy substituted alkyl acrylates including 2-biphenylhexyl acrylate, benzyl acrylate, 2-phenoxyethyl acrylate, and 2-phenylethyl acrylate.

In this case, the copolymer obtained from the polar monomers can have a weight average molecular weight of from 200,000 g/mol to 1,500,000 g/mol, from 300,000 g/mol to 900,000 g/mol, from 500,000 g/mol to 900,000 g/mol, or in some embodiments, less than, equal to, or greater than 200,000 g/mol; 300,000; 400,000; 500,000; 600,000; 700,000; 800,000; 900,000; 1,000,000; 1,100,000; 1,200,000; 1,300,000; 1,400,000; or 1,500,000 g/mol.

Various other monomers could be included in the mixture of low T_{g} monomers used to polymerize the second (meth)acrylic functional additive where the T_{g} and molecular weight properties described above are retained. Acrylic acid, for example, can be added in small amounts to afford an adhesive with improved moisture tolerance.

The amount of the second (meth)acrylic functional additive present in the adhesive composition is generally small compared with that of the first (meth)acrylic functional additive. Where present, the second (meth)acrylic functional additive can be present in an amount of from 0.5% to 10%, from 1% to 7%, from 2% to 4%, or in some embodiments, less than, equal to, or greater than 0.5, 0.6, 0.7, 0.8, 0.9, 1, 1.1, 1.2, 1.5, 1.7, 2, 2.5, 3, 3.5, 4, 4.5, 5, 5.5, 6, 6.5, 7, 7.5, 8, 8.5, 9, 9.5, or 10% by weight relative to the total weight of the adhesive composition.

### Hydrocarbon Tackifier

The provided pressure sensitive adhesive compositions contain a first tackifier compatible with the rubbery midblock segment and comprising a hydrocarbon.

The first tackifier is compatible with the rubbery block of the styrenic block copolymer and can be an aliphatic hydrocarbon tackifier, a terpene tackifier, a terpene phenolic tackifier, or a mixture thereof. The hydrocarbon tackifier is preferably compatible with the rubbery block but not with the glassy blocks of the block copolymer component. When incorporated into the pressure sensitive adhesive composition in suitable quantities, the addition of the hydrocarbon tackifier can improve adhesion of the pressure sensitive adhesive composition to low surface energy substrates.

The compatibility of the tackifier with the rubbery block can be determined by measuring the effect of the tackifier on the glass transition temperature of the rubbery block. If a tackifier is compatible, it will generally increase the glass transition temperature of the rubber block. Tackifiers such as hydrocarbon tackifiers, terpene tackifiers, and terpene phenolic tackifiers tend to be especially compatible with the rubbery block.

Useful hydrocarbon tackifiers include aliphatic hydrocarbon resins. In some embodiments, the aliphatic hydrocarbons are fully hydrogenated. Examples of hydrocarbon tackifiers include, but are not limited to, those commercially available under the trade designation ARKON (e.g., ARKON P140 and ARKON P125) from Arakawa Europe GmbH in Eschborn, Germany, under the trade designation REGALREZ (e.g., REGALREZ 1126) from Eastman Chemical Co. in Kingsport, Tenn., REGALITE (e.g., REGALITE 1125) from Eastman Chemical Co., under the trade designation ESCOREZ (e.g., ESCOREZ 5615, 5320, 1315, 1304, 5637, and 5340) from ExxonMobil Chemical Company in Spring, Tex., under the trade designation OPPERA (e.g., OPPERA PR 100A) from Exxon, under the trade designation NEVTAC (e.g., NEVTAC 115) from Neville Chemical Company in Pittsburgh, Pa., under the trade designation H-REZ (e.g., H-REZ C9 125H) from NUROZ LLC, in Miami, Fla., under the trade designation ALPHATAC (e.g., ALPHATACK 115) from R. E. Carroll, Inc. in Ewing, N.J., under the trade designation RESINALL (e.g., RESINALL 1030 and 1030A) from Resinall Corporation in Severn, N.C., and under the trade designation FUCLEAR (FUCLEAR FP-125 and FP-100) from United Performance Materials Corporation in Taipei, Taiwan.

Other suitable hydrocarbon tackifiers include terpenes. Terpenes include polyterpenes (e.g., alpha pinene-based resins, beta pinene-based resins, and limonene-based resins). Examples of terpenes include those available under the trade designation CLEARON (e.g., CLEARON P150 and P135) from Yasuhara Chemical Company, Ltd. in Hiroshima, Japan.

Still other suitable first tackifiers include terpene phenolic resins, also referred to as terpene phenolic tackifiers, or terpene phenolics. Example terpene phenolics include, but are not limited to, those available under the trade designation YS POLYSTER (e.g., POLYSTER T115, T160, T130, S145, and G150) from Yasuhara Chemical Company, Ltd. In Hiroshima, Japan.

The hydrocarbon tackifier can have a softening point from 80° C. to 160° C., from 100° C. to 150° C., from 115° C. to 145° C., or in some embodiments, less than, equal to, or greater than 80° C., 85, 90, 95, 100, 105, 110, 115, 120, 125, 130, 135, 140, 145, 150, 155, or 160° C. In some embodiments, the hydrocarbon tackifier is an aliphatic polymer to provide the desired compatibility with the rubbery block and to minimize compatibility with the glassy blocks.

The amount of the first tackifier present in the pressure sensitive adhesive composition can be from 15% to 50%, from 20% to 45%, from 25% to 40%, or in some embodiments, less than, equal to, or greater than 15%, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50% by weight relative to the overall weight of the adhesive composition. If the amount is too high, the glass transition temperature of the resulting pressure sensitive adhesive composition may be so high that it would not function as a pressure sensitive adhesive. If the amount is too low, however, the modulus may be too high and the pressure sensitive adhesive composition may not wet out well on substrate surfaces.

### Polyphenylene Ether Tackifier

The provided pressure sensitive adhesive compositions further contain a second tackifier that is compatible with the glassy end block segment and comprises a phenyl ether polymer such as polyphenylene ether or polyphenylene oxide. In some embodiments, the phenyl ether polymer contains the repeating unit shown in Structure I below:

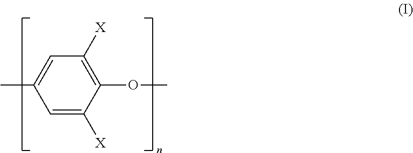

wherein each X is independently a monovalent substituent selected from the group consisting of hydrogen, halogen, hydrocarbon radicals, halohydrogen radicals having at least two carbon atoms between the halogen atom and the phenyl nucleus, hydrocarbonoxy radicals, and halohydrocarbonoxy radicals having at least two carbon atoms between the halogen atoms and phenyl nucleus. In some embodiments, each X is a methyl group.

In some embodiments, the phenyl ether polymer is a polyphenylene ether that does not have any substituents on the phenoxy unit, and where the linkages are not at para positions.

By increasing the glass transition temperature of the glassy blocks of the block copolymer component, inclusion of the polyphenylene ether resin can significantly increase the service temperature of the adhesive. The polyphenylene ether resins have a T_{g} and molecular weight within ranges that allow the resin to be compatible with the glassy block copolymer component. Suitable polyphenylene ether resins are commercially available under the trade designation SA90 and SA120 from Sabic in Riyadh, Saudi Arabia.

The polyphenylene ether resin can provide the tackifier with a softening point of from 100° C. to 230° C., from 120° C. to 220° C., from 135° C. to 175° C., or in some embodiments, less than, equal to, or greater than 100° C., 105, 110, 115, 120, 125, 130, 135, 140, 145, 150, 155, 160, 165, 170, 175, 180, 185, 190, 195, 200, 205, 210, 215, 220, 225, and 230° C.

Polyphenylene ether resins can have a weight average molecular weight (M_{W}) of from 1,000 to 25,000 g/mol, from 2,000 to 10,000 g/mol, from 4,000 to 8,000 g/mol, or in some embodiments, less than, equal to, or greater than 1,000 g/mol; 1,200; 1,500, 1,700; 2,000; 2,500; 3,000; 3,500; 4,000; 4,500; 5,000; 5,500; 6,000; 6,500; 7,000; 7,500; 8,000, 8,500; 9,000; 9,500; 10,000; 11,000; 12,000; 13,000; 14,000; 15,000; 16,000; 17,000; 18,000; 19,000; 20,000; 21,000; 22,000; 23,000; 24,000; 25,000; 30,000; 35,000; 40,000; 45,000; or 50,000 g/mol.

The second tackifier may be comprised partly or entirely of one or more polyphenylene ether resins. The amount of the second tackifier present in the adhesive composition is generally smaller than the amount of the first tackifier and can be from 1% to 15%, from 2% to 10%, from 4% to 8%, or in some embodiments, less than, equal to, or greater than 1%, 1.5, 2, 2.5, 3, 3.5, 4, 4.5, 5, 5.5, 6, 6.5, 7, 7.5, or 8% by weight relative to the overall weight of the pressure sensitive adhesive composition.

Polyphenylene ether resins can be made by any known method. Suitable methods of preparation are described in U.S. Pat. No. 3,306,874 (Hay); U.S. Pat. No. 3,306,875 (Hay); U.S. Pat. No. 3,257,357 (Stamatoff); and 3,257,358 (Stamatoff).

### Further Optional Additives

Other fillers may be included in the provided pressure sensitive adhesive compositions to afford functional and ornamental features.

In some embodiments, the pressure sensitive adhesive composition is a foamed composition. The foamed pressure sensitive adhesive can be prepared by mixing into the adhesive composition a physical blowing agent, chemical blowing agent, or a low-density filler. Useful low-density fillers include, for example, hollow glass microspheres.

Foamed pressure sensitive adhesive compositions not only reduce weight but can be advantageous in applications where it is necessary for the adhesive to conform to surfaces that are rough or irregularly shaped. The foam can be an open cell foam or a closed cell foam. The foams can be formed by any known method such as using a blowing agent or by including expandable microspheres in the pressure sensitive adhesive composition. The foam can include either a thermoplastic or thermoset polymeric material. Exemplary foams include acrylic-based foams, polyethylene foams, and polyurethane foams. In some embodiments, the foam is a flexible foam. One particular foam that is useful in some embodiments is an acrylic-based foam formed using expandable microspheres. Generally, a flexible foam is a foam which, when in sheet form, can be bent back upon itself without fracturing. Other exemplary foams are described in the Handbook of

Polymer Foams, David Eaves, editor, published by Shawbury, Shrewsbury, Shropshire, UK: Rapra Technology, 2004.

### Adhesive Assemblies

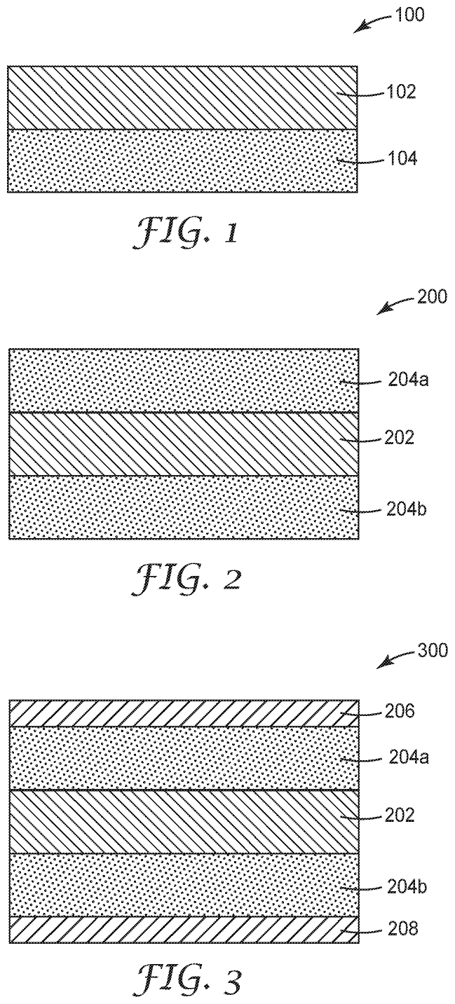

A pressure sensitive adhesive-backed tape 100 according to one aspect of this disclosure is illustrated in FIG. 1. The adhesive-backed tape 100 includes a flexible backing 102 and a pressure-sensitive adhesive layer 104 made from the pressure sensitive adhesive composition as described above. Pressure sensitive adhesive layer 104 is present as a layer extending across and directly contacting the backing 102. In this embodiment, no primer layer is needed or present between the backing 102 and the pressure sensitive adhesive layer 104. In other embodiments, primer layers or other intervening or tie layers may be sandwiched between the backing and the pressure sensitive adhesive layer.

Flexible backing 102 can be made from any known material suitable for tape backings. Materials suitable for the flexible backing 102 include acrylic foam, polymeric foams and solid films made from polyolefins, such as polyethylene, including high density polyethylene, low density polyethylene, linear low density polyethylene, and linear ultra-low density polyethylene, polypropylene, and polybutylenes; vinyl copolymers, such as polyvinyl chlorides, both plasticized and unplasticized, and polyvinyl acetates; olefinic copolymers, such as ethylene/methacrylate copolymers, ethylene/vinyl acetate copolymers, acrylonitrile-butadiene-styrene copolymers, and ethylene/propylene copolymers; acrylic polymers and copolymers; polyurethanes; and combinations thereof. If the flexible backing 102 is a foam, it can be either an open-cell foam or closed-cell foam. In some embodiments, the foam is a flexible foam. One particular foam is an acrylic-based foam formed using expandable microspheres. Generally, a flexible foam is a foam which, when in sheet form, can be bent back upon itself without fracturing. Other exemplary foams are described in the Handbook of Polymer Foams, David Eaves, editor, published by Shawbury, Shrewsbury, Shropshire, UK: Rapra Technology, 2004. Further, the flexible backing 102 may be made from an adhesive or non-adhesive material. Further, the flexible backing 102 may include papers, metal foils, and woven and nonwoven webs.

FIG. 2 shows double-sided pressure sensitive adhesive tape 200 that include a first pressure sensitive adhesive layer 204a disposed on or adjacent a major side of a flexible backing 202 opposite that of a second pressure sensitive adhesive layer 204b. Such a dual-sided construction may be used, for instance, when bonding two different substrates to each another. The second pressure sensitive adhesive layer 204b may be made from the same pressure sensitive adhesive layer or a different pressure sensitive adhesive layer from the first pressure sensitive adhesive layer 204a. The pressure sensitive adhesive used in the pressure sensitive adhesive layers has a formulation and method of manufacture as described above.

FIG. 3 shows double-sided pressure sensitive adhesive tape 300 that is the construction of the embodiment shown in FIG. 2, but additionally including release liners 206 and 208, sandwiching the construction of FIG. 2.

Either or both of the first and second substrates 206, 208 can be made from a medium surface energy material, such as a polycarbonate. Suitable substrates can be provided with any suitable size or shape. In one useful application, the substrate is a clear coat layer, such as low surface energy clear coat layer, as might be provided on an aerospace or automotive exterior surface.

The substrate 206 and 208 may comprise a release liner as is known in the art. Suitable release liners are removeable from the adjacent pressure sensitive adhesive layers. The release liner could be made with flexible films, such as those made from polyolefin (e.g. polyethylene or polypropylene) or polyester (e.g. polyethylene teraphthalate) or from papers such as super calendared kraft papers or polyolefin coated papers. Such films and papers may be treated with a release layer made from silicones, waxes, or fluorocarbons, and the like.

The first pressure sensitive adhesive layer can be positioned adjacent to the release liner. In some embodiments, the first pressure sensitive adhesive layer is positioned between a first substrate 206 that is a release liner and a second substrate 208 that is also a release liner. The pressure sensitive adhesive tape in one embodiment includes in the following order: a first release liner, a pressure sensitive adhesive layer, and a second release liner. Alternatively, in other embodiments, the first substrate 206 is a flexible backing and the second substrate 208 is a release liner. The article includes in the following order: a flexible backing, a pressure sensitive adhesive layer, and a release liner.

In another embodiment similar to that shown in FIG. 3, one of the release liners 206 or 208 may be omitted, allowing the tape construction to be self-wound.

Tapes of the above constructions may be generally assembled by disposing a pressure sensitive adhesive on a substrate (be it a liner or flexible backing), then effecting crosslinking of the pressure sensitive adhesive by exposing the resultant assembly to a suitable dose of electron beam radiation. In some embodiments, a foam flexible backing and the pressure sensitive adhesive layer or layers are co-extruded. Methods of extruding polymeric foams and methods of coextruding polymer foams and adhesives layers are described, e.g., in U.S. Pat. No. 6,103,152 (Gehlsen et al.) and U.S. Pat. No. 6,630,531 (Khandpur et al.).

The first pressure sensitive adhesive layer may be disposed on the backing or release liner by any suitable method such as, for example, by laminating or coating (e.g., knife coating, roll coating, gravure coating, rod coating, curtain coating, spray coating, or air knife coating).

The pressure sensitive adhesive layers are crosslinked with electron beam radiation to impart more desirable characteristics to the pressure sensitive adhesive tape or pressure sensitive adhesive foam tape, such as increased strength. Electron beam radiation is advantageous because it can cross link polymers that other methods having lower raditation penetration (such as UV) cannot, including for example highly pigmented pressure sensitive adhesive layers, pressure sensitive adhesive layers with fillers, and relatively thick pressure sensitive adhesive layers.

Electron beam radiation causes crosslinking of the adhesive by initiating a free-radical chain reaction. Ionizing radiation from the electron beam is absorbed directly in the polymer and generates free radicals that initiate the crosslinking process. Generally, electron energies of about 100 keV are necessary to break chemical bonds and ionize, or excite, components of the polymer system. Therefore, the scattered electrons that are produced to a large population of free radicals throughout the pressure sensitive adhesive layer. These radicals initiate the polymerization reaction. This polymerization process results in a three-dimensional crosslinked polymer.

An electron beam processing unit supplies the radiation for the pressure sensitive adhesive tape manufacturing process. Generally, a processing unit includes a power supply and an electron beam acceleration tube. The power supply increases and rectifies the current, and the accelerator generates and focuses the electron beam and controls the scanning. The electron beam may be produced, for example, by energizing a tungsten filament with high voltage. This causes electrons to be produced at high rates. These electrons are then concentrated to form a high energy beam and are accelerated inside the electron gun. Electromagnets on the sides of the accelerator tube allow deflection, or scanning, of the beam, to which the pressure sensitive adhesive is exposed.

The total dosage of electron beam radiation should be as low as needed to effectively crosslink the adhesive and effect desired adhesive performance (on substrates and at various temperatures—see Examples section for more disclosure in this regard), while minimizing negative effects of the radiation on the adhesive or adjacent substrates (such as liners or backings). In some embodiments, a suitable dose of electron beam radiation is 2, 3, 4, 5, 6, 7, 8, 9, 10, 11, 12, 13, 14, 15, 16, 17, 18, 19, 20, 21, 22, 23, or 24 megarads. Ranges between these values are also possible. In some preferred embodiments, radiation dosages are 2, 5, 10, or 15 megarads have shown good efficacy and balance of desired properties (see Examples section).

Various embodiments are provided that include pressure-sensitive adhesive compositions, articles containing the pressure-sensitive adhesive compositions, and methods of making the articles.

While not intended to be limiting, further exemplary embodiments are provided as follows.
1. A pressure sensitive adhesive layer comprising a pressure sensitive adhesive composition comprising: a block copolymer component comprising a midblock segment and a plurality of end block segments, each end block segment comprising polystyrene; a (meth)acrylic functional additive having a glass transition temperature of from 50° C. to 160° C.; a first tackifier compatible with the midblock segment and comprising a hydrocarbon; and a second tackifier compatible with the end block segments and comprising a polyphenylene ether.
2. The pressure sensitive adhesive composition of embodiment 1, wherein the (meth)acrylic functional additive has a glass transition temperature of from 60° C. to 150° C.
3. The pressure sensitive adhesive composition of embodiment 2, wherein the (meth)acrylic functional additive has a glass transition temperature of from 75° C. to 120° C.
4. The pressure sensitive adhesive composition of any one of embodiments 1-3, wherein the first tackifier has a softening point temperature of from 80° C. to 160° C.
5. The pressure sensitive adhesive composition of embodiment 4, wherein the first tackifier has a softening point temperature of from 100° C. to 150° C.
6. The pressure sensitive adhesive composition of embodiment 5, wherein the first tackifier has a softening point temperature of from 115° C. to 145° C.
7. The pressure sensitive adhesive composition of any one of embodiments 1-6, wherein the second tackifier has a softening point temperature of from 100° C. to 230° C.
8. The pressure sensitive adhesive composition of embodiment 7, wherein the second tackifier has a softening point temperature of from 120° C. to 220° C.
9. The pressure sensitive adhesive composition of embodiment 8, wherein the second tackifier has a softening point temperature of from 135° C. to 170° C.
10. The pressure sensitive adhesive composition of any one of embodiments 1-9, wherein the polyphenylene ether has a number average molecular weight of from 300 g/mol to 50,000 g/mol.
11. The pressure sensitive adhesive composition of embodiment 10, wherein the polyphenylene ether has a number average molecular weight of from 1000 g/mol to 20,000 g/mol.
12. The pressure sensitive adhesive composition of embodiment 11, wherein the polyphenylene ether has a number average molecular weight of from 1500 g/mol to 2500 g/mol.
13. The pressure sensitive adhesive composition of any one of embodiments 1-12, wherein the (meth)acrylic functional additive has a weight average molecular weight of from 1000 g/mol to 300,000 g/mol.
14. The pressure sensitive adhesive composition of embodiment 13, wherein the (meth)acrylic functional additive has a weight average molecular weight of from 10,000 g/mol to 75,000 g/mol.
15. The pressure sensitive adhesive composition of embodiment 14, wherein the (meth)acrylic functional additive has a weight average molecular weight of from 25,000 g/mol to 40,000 g/mol.
16. The pressure sensitive adhesive composition of any one of embodiments 1-15, wherein the block copolymer component comprises a mixture of two of more of styrenic diblock, styrenic triblock, and styrenic star block copolymers.
17. The pressure sensitive adhesive composition of any one of embodiments 1-16, wherein the midblock segment comprises polyisoprene, polybutadiene, poly(ethylene/butylene), poly(ethylene/propylene), polyisobutylene or a copolymer or mixture thereof
18. The pressure sensitive adhesive composition of any one of embodiments 1-17, wherein the block copolymer component has an average styrene content of from 7% to 40% by weight.
19. The pressure sensitive adhesive composition of embodiment 18, wherein the block copolymer component has a styrene content of from 9% to 33% by weight.
20. The pressure sensitive adhesive composition of embodiment 19, wherein the block copolymer component has a styrene content of from 13% to 25% by weight.
21. The pressure sensitive adhesive composition of any one of embodiments 1-20, wherein the block copolymer component is present in amount of from 30% to 60% by weight relative to the overall weight of the composition.
22. The pressure sensitive adhesive composition of embodiment 21, wherein the block copolymer component is present in amount of from 35% to 55% by weight relative to the overall weight of the composition.
23. The pressure sensitive adhesive composition of embodiment 22, wherein the block copolymer component is present in amount of from 40% to 50% by weight relative to the overall weight of the composition.
24. The pressure sensitive adhesive composition of any one of embodiments 1-23, wherein the first tackifier is present in amount of from 15% to 50% by weight relative to the overall weight of the composition.
25. The pressure sensitive adhesive composition of embodiment 24, wherein the first tackifier is present in amount of from 20% to 45% by weight relative to the overall weight of the composition.
26. The pressure sensitive adhesive composition of embodiment 25, wherein the first tackifier is present in amount of from 25% to 40% by weight relative to the overall weight of the composition.
27. The pressure sensitive adhesive composition of any one of embodiments 1-26, wherein the second tackifier is present in amount of from 1% to 15% by weight relative to the overall weight of the composition.
28. The pressure sensitive adhesive composition of embodiment 27, wherein the second tackifier is present in amount of from 2% to 10% by weight relative to the overall weight of the composition.
29. The pressure sensitive adhesive composition of embodiment 28, wherein the second tackifier is present in amount of from 4% to 8% by weight relative to the overall weight of the composition.
30. The pressure sensitive adhesive composition of any one of embodiments 1-29, wherein the (meth)acrylic functional additive is present in amount of from 1% to 12% by weight relative to the overall weight of the composition.
31. The pressure sensitive adhesive composition of embodiment 30, wherein the (meth)acrylic functional additive is present in amount of from 2% to 8% by weight relative to the overall weight of the composition.
32. The pressure sensitive adhesive composition of embodiment 31, wherein the (meth)acrylic functional additive is present in amount of from 3% to 6% by weight relative to the overall weight of the composition.
33. The pressure sensitive adhesive composition of any one of embodiments 1-32, wherein the (meth)acrylic functional additive is a first (meth)acrylic functional additive and further comprising a second (meth)acrylic functional additive having a glass transition temperature of from −60° C. to 25° C.
34. The pressure sensitive adhesive composition of embodiment 33, wherein the second (meth)acrylic functional additive has a glass transition temperature of from −55° C. to 10° C.
35. The pressure sensitive adhesive composition of embodiment 34, wherein the second (meth)acrylic functional additive has a glass transition temperature of from −50° C. to 0° C.
36. The pressure sensitive adhesive composition of any one of embodiments 33-35, wherein the second (meth)acrylic functional additive has a weight average molecular weight of from 200,000 g/mol to 1,500,000 g/mol.
37. The pressure sensitive adhesive composition of embodiment 36, wherein the second (meth)acrylic functional additive has a weight average molecular weight of from 300,000 g/mol to 900,000 g/mol.
38. The pressure sensitive adhesive composition of embodiment 37, wherein the second (meth)acrylic functional additive has a weight average molecular weight of from 500,000 g/mol to 900,000 g/mol.
39. The pressure sensitive adhesive composition of any one of embodiments 33-38, wherein the second (meth)acrylic functional additive is present in amount of from 0.5% to 10% by weight relative to the overall weight of the composition.
40. The pressure sensitive adhesive composition of embodiment 39, wherein the second (meth)acrylic functional additive is present in amount of from 1% to 7% by weight relative to the overall weight of the composition.
41. The pressure sensitive adhesive composition of embodiment 40, wherein the second (meth)acrylic functional additive is present in amount of from 2% to 4% by weight relative to the overall weight of the composition.
42. The pressure sensitive adhesive composition of any one of embodiments 1-41, wherein the adhesive composition is a pressure-sensitive adhesive.
43. A pressure sensitive adhesive tape comprising: a flexible backing; and a pressure sensitive adhesive layer disposed on the flexible backing and comprised of the pressure sensitive adhesive composition of any one of embodiments 1-42.
44. The pressure sensitive adhesive tape of embodiment 43, wherein the flexible backing comprises a foam.
45. The pressure sensitive adhesive tape of embodiment 43 or 44 wherein the pressure sensitive adhesive layer is a first pressure sensitive adhesive layer and further comprising a second pressure sensitive adhesive layer disposed on a side of the flexible backing opposite that of first pressure sensitive adhesive layer.
46. The pressure sensitive adhesive tape of any one of embodiments 43-45, wherein the second pressure sensitive adhesive layer comprises the same pressure sensitive adhesive layer composition as that of the first pressure sensitive adhesive layer.
47. A bonded assembly comprising: a first substrate and a second substrate, wherein any of the tapes of embodiments 1-46 are used to bond the two substrates together.

### EXAMPLES

Objects and advantages of this disclosure are further illustrated by the following non-limiting examples, but the particular materials and amounts thereof recited in these examples, as well as other conditions and details, should not be construed to unduly limit this disclosure. Unless otherwise noted, all parts, percentages, ratios, etc. in the Examples and the rest of the specification are by weight. Unless otherwise noted, all parts, percentages, ratios, etc. in the Examples and the rest of the specification are by weight. Unless otherwise indicated, all other reagents were obtained, or are available from fine chemical vendors such as Sigma-Aldrich Company, St. Louis, Mo., or may be synthesized by known methods. The following abbreviations are used in this section: min=minutes, s=second, g=gram, mg=milligram, kg=kilogram, lb=pound, m=meter, centimeter=cm, mm=millimeter, μm=micrometer or micron, in=inch, ° C.=degrees Celsius, ° F.=degrees Fahrenheit, N=Newton, oz=ounce, Pa=Pascal, MPa=mega Pascal, rpm=revolutions per minute, pwb=parts by weight, pph=parts per hundred, psi=pressure per square inch, cc/rev=cubic centimeters per revolution, cm³=centimeters cubed, rad=radians, ppm=parts per million, megarads=mega radians, RH=relative humidity, M_{W}=molecular weight, PSA=pressure sensitive adhesive, keV=kilo electron volt.

TABLE 1
Materials

| | |
|---|---|
| IOA | Isooctyl acrylate, obtained from 3M Company, St. Paul, MN |
| 2EHA | 2-ethylhexyl acrylate, obtained from BASF Corporation, Florham Park, NJ |
| AA | Acrylic acid, obtained from BASF Corporation, Florham Park, NJ |
| BA | Butyl acrylate, obtained from BASF Corporation, Florham Park, NJ |
| IBOA | Isobornyl acrylate, obtained from Chempoint, a Univar Company, Calumet City, IL |
| IOTG | Isooctylthioglycolate, obtained from Showa Denko Corporation, Tokyo, Japan |
| D1161 | A styrene-isoprene-styrene triblock copolymer having an approximate styrene content of |
| | 15% and 19% diblock content, obtained under the trade designation “KRATON D1161 |
| | P” from Kraton Performance Polymers, Houston, TX |
| D1118 | A styrene-butadiene-styrene triblock copolymer having an approximate styrene content of |
| | 33% and 78% diblock content, obtained under the trade designation “KRATON D1118” |
| | from Kraton Performance Polymers, Houston, TX |
| SA90 | A low molecular weight oligomer based on polyphenylene ether with a glass transition |
| | temperature of 140 degrees Celsius, and a number average molecular weight of 1600 |
| | grams per mole, obtained under the trade designation “SA90” from SABIC, Riyadh, |
| | Saudi Arabia |
| P140 | A fully hydrogenated hydrocarbon resin with a softening point of 140° C., obtained under |
| | the trade designation “ARKON P140” from Arakawa, Osaka, Japan |
| E5340 | A cycloaliphatic hydrocarbon resin with softening point of 140° C., obtained under the |
| | trade designation “ESCOREZ 5340” from ExxonMobil Chemical Company, Spring, TX |
| P125 | A fully hydrogenated hydrocarbon resin with a softening point of 125° C., obtained under |
| | the trade designation “ARKON P125” from Arakawa, Osaka, Japan |
| EVA-CB | A pelletized ethyl vinyl acetate containing carbon black at a concentration of 50 wt %, |
| | obtained under the trade designation “4105 VAC BLACK”, from PolyOne Corporation, |
| | Avon Lake, OH |
| IRG651 | 2-dimethoxy-2-phenylacetophenone, a photoinitiator, obtained under the trade |
| | designation “IRGACURE 651” from BASF Corporation, Florham Park, NJ |
| IRG1010 | Pentaerythritoltetrakis(3-(3,5-ditertbutyl-4-hydroxyphenyl)propionate), an antioxidant, |
| | obtained under the trade designation “IRGANOX 1010”, available from BASF |
| | Corporation, Florham Park, NJ |
| PC | Makrolon PC test panels of 3 mm thick, length and width dimensions vary and are |
| | specified in test methods, available from Plastics International, Eden Prairie, MN |
| RELEASE | A 0.003 inch (76 micrometers) thick polyester release liner having a different silicone |
| LINER 1 | release coating on each side to provide a differential release force, obtained from 3M |
| | Company, Maplewood, MN |
| RELEASE | Hostaphan 2SLK3N, a 50 micrometers thick polyester release liner having a silicone |
| LINER 2 | release coating on one side, obtained from Mitsubishi Polyester Film, Inc., Greer, S.C |
| RELEASE | RF22N, a 75 micrometers thick polyester release liner having a silicone release coating on |
| LINER 3 | one side, obtained from SKC Haas, Seoul, Korea |
| PET | HOSTAPHAN 3SAB, 200 gauge (50 micrometers) single side treated PET film, obtained |
| | from Mitsubishi Polyester Film, Inc., Greer, S.C |

### Test Methods

### Peel Adhesion to Polycarbonate Test

The Peel Adhesion to Polycarbonate was measured in accordance to ASTM D3330/D3330M-04 (2010) Test Method E—Adhesion of Adhesive Transfer Tapes 15.1 Face Side and 1 and Test Method F—Single Coated Tapes at 90° Angle using an IMASS SP 2100 peel force tester with a 20 lb [9.07 Kg] load cell and set to 305 mm/min with a 2 second delay and 10 second averaging time with the following specifications. The test panel used was PC cut to a dimension of 5.08 cm wide by 12.7 cm long, heated in an oven set to 85° C. for 24 hours before use. The PC test panel was used one time. The sample specimen was 25.4 mm width and was superimposed onto an aluminum foil of 0.127 mm thick cut to 12.7 mm width by approximately 20 cm length. The test specimen on aluminum foil was placed on the PC test panel and rolled down mechanically using two passes of a 2.3 kilograms roller in each direction at a rate of 24 in/min. The pressure sensitive tape specimen was dwelled on the PC panel for 72 hrs and Peel Adhesion to Polycarbonate was measured at 21° C. and 50% RH conditions. The average peel force was measured in oz/in and converted to N/cm. The data is reported as an average of two measurements.

### Initial Cold Peel Adhesion to Polycarbonate Test

The Initial Cold Peel Adhesion to Polycarbonate was measured in accordance to ASTM D3330/D3330M-04 (2010) Test Method E—Adhesion of Adhesive Transfer Tapes 15.1 Face Side and 1 and Test Method F—Single Coated Tapes at 90° Angle using an IMASS SP 2100 peel force tester with a 20 lb [9.07 Kg] load cell and set to 305 mm/min with a 2 second delay and 10 second averaging time with the following specifications. The test panel used was PC cut to a dimension of 5.08 cm wide by 12.7 cm long, heated in an oven set to 85° C. for 24 hours, and then reconditioned in a walk-in cooler set to 5 degrees Celsius for 90 minutes before use. The PC test panel was used one time. The sample specimen was 6.4 mm width and was superimposed onto an aluminum foil of 0.127 mm thick cut to 12.7 mm width by approximately 20 cm length. The test specimen on aluminum foil was placed on the PC test panel and rolled down mechanically using two passes of a 2.3 kilograms roller in each direction at a rate of 24 in/min. The sample specimen was conditioned for 90 minutes, prepared on the PC panel in the walk-in cooler set to 5 degrees Celsius. The Initial Cold Peel Adhesion to Polycarbonate of the pressure sensitive tape specimen to the PC panel was measured after a dwell of 30 seconds on the PC panel at the 5 degrees Celsius conditions. The Average Initial Cold Peel Adhesion to Polycarbonate was measured in lb/0.25 in and converted to N/cm. The data is reported as an average of two measurements.

### Static Shear Adhesion to Polycarbonate Test

The Static Shear Adhesion to Polycarbonate was measured in accordance to ASTM D3654/D3654M-06 (2011) procedure A or H. Except the substrate panel used was PC cut to a dimension of 6.35 cm×5.08 cm, heated in an oven set to 85° C. for 24 hours prior to use, and was used one time. For procedures A and H, the sample area was 25.4 mm×25.4 mm and the load was 500 g. The temperature used for procedure H was 70 or 105 degrees Celsius. The time to failure was measured in minutes for each test specimen and reported as an average of two tests. The test was stopped after 10,000 minutes if failure had not occurred by then. Static Shear Adhesion to Polycarbonate times of greater than or equal to 2,000 minutes were desirable, and optionally, greater than or equal to 10,000 minutes.

### Static T-Block Tensile Adhesion to Polycarbonate Test

The Static T-Block Tensile Adhesion to Polycarbonate was measured at 105 degree Celsius for a pressure sensitive adhesive foam tape. A pressure sensitive adhesive foam tape specimen of 2 square cm is applied between a top horizontally oriented PC panel and bottom hardened aluminum T-block fixture fitted with a weight of 200 g. The T-block fixture was made from a Multipurpose 6061 Aluminum T-Bar 1668T22 with a 1.27 cm height, 1.5875 cm width, and 1.27 mm wall thickness obtained from McMaster-Carr Supply Company, Elmhurst, Ill. The aluminum T-bar was cut to a length of 1.259 cm to make a T-block test fixture with test surface of 2.0 square centimeters area. The aluminum T-block fixture was drilled with a hole into the vertical part of the T for securing a weight. The PC panel was cut to 5.08 cm width×7.47 cm length heated in an oven set to 85° C. for 24 hours prior to use and was used one time. A pressure sensitive adhesive foam tape sample of approximately 3 cm by 3 cm was cut and the first release liner was removed. The T-block fixture was pressed onto the exposed surface of the pressure sensitive adhesive foam tape and the excess was trimmed to 2 square cm area of the fixture. The second release liner was removed and the pressure sensitive adhesive foam tape with T-block fixture was adhered to the center of the PC panel. A compressive pressure of 440 kilopascals for 5 seconds was applied to the PC panel, pressure sensitive adhesive foam tape, and T-block fixture, resulting in a bonded test structure without air bubbles at the interfaces of the pressure sensitive adhesive foam tape and the PC panel or the aluminum T-block fixture. The pressure sensitive adhesive foam tape in the test structure was conditioned for 24 hours at 23 degrees Celsius and 50% relative humidity. The conditioned bonded test structure was then placed in a horizontally oriented position with the PC panel on top into a static shear stand stationed within a 105 degrees Celsius S-OSI-8 Shear Oven System obtained from Cheminstruments Inc., Fairfield, Ohio After the test structure was conditioned at 105 degrees Celsius for 10 minutes, a 200 g weight was secured to the T-block fixture and a timer was initiated. The Static T-Block Tensile Adhesion to Polycarbonate test fails when the pressure sensitive adhesive foam tape can no longer hold the weighted T-block fixture and it falls away from the PC panel. The Static T-Block Tensile Adhesion to Polycarbonate was measured in minutes to failure or to 10,000 minutes, whichever occurs first.

### Foam Density

The foam density was measured by a gravimetric method. A foam specimen of 10.1 cm by 15.2 cm was cut using a steel rule die. The caliper of the foam specimen was measured using a Mitotoyo Absolute Digimatic Indicator gauge obtained from Mitutoyo of America located in Aurora, Ill. The average of 5 replicate caliper measurements was calculated. The weight of the foam was measured with an analytical balance. The volume of the specimen was calculated using the average caliper and die cut area. The density in units of Kg/square meters was calculated by dividing the weight by the volume of the foam specimen.

### Liner Release Test

The Liner Release was measured in accordance to ASTM D3330/D3330M-04 (2010) Method D 14.2 for single coated pressure sensitive adhesive tapes using an IMASS SP 2100 peel force tester with a 44.5 N load cell and set to 2286 mm/min with a 1 second delay and 2 second averaging time. The Liner Release was measured on a 25.4 mm wide test specimen. The average release was measured in g/in and converted to g/cm and reported as an average of two test specimens. The desired Liner Release values will vary depending on application, however, in general Liner Release of less than 100 g/cm is preferred, and liner release of less than 50 g/cm is more preferred.

### Glass Transition Temperature (T_{g})

The glass transition temperatures of the HTG and LTG Acrylic Copolymers (i.e., the first and second acrylic functional additives, respectively) were calculated using the Fox Equation:

1/T_{g}=ΣWi/T_{g}i.

In this equation, T_{g} is the glass transition temperature of the mixture, Wi is the weight fraction of component i in the mixture, and T_{g}i is the glass transition temperature of component i, and all glass transition temperatures are in degrees Kelvin (° K). The values used for each T_{g}i were taken from a list provided by Sigma-Aldrich Corporation, St. Louis, Mo. Selected T_{g} values are listed in Table 6 below.

### Preparations

### Preparation of Polymodal Asymmetric Block Copolymer (PASBC)

A polymodal, asymmetric star block copolymer (“PASBC”) was prepared according to U.S. Pat. No. 5,393,787, the subject matter of which is hereby incorporated by reference in its entirety. The polymer had a number average molecular weights of about 4,000 Daltons and about 21,500 Daltons for the two end blocks, 127,000-147,000 Daltons for the arm, and about 1,100,000 Daltons for the star measured by SEC (size exclusion chromatography) calibrated using polystyrene standards. The polystyrene content was between 9.5 and 11.5 percent by weight. The mole percentage of high molecular weight arms was estimated to be about 30%.

### Preparation of Acrylic Copolymer (HTG-1, LTG-1)

Two sheets of a heat-sealable ethylene/vinyl acetate film having a vinyl acetate content of 6% and a thickness of 0.0635 millimeters (0.0025 inches) (obtained under the trade designation “VA24”, from Consolidated Thermoplastics Co., Schaumburg, Ill.) were heat sealed on their lateral edges and the bottom using a liquid form, fill, and seal machine to form a rectangular tube measuring 5 cm (1.97 inches) wide. The tube was then filled with one of the compositions shown in Table 2 to make Acrylic copolymers HTG-1 and LTG-1. The monomer amounts are reported in parts by weight (pbw) and IRG651, IOTG, and DAR1173 are reported in parts per 100 part of total monomer (pph).

The filled tube was then heat sealed at the top and at periodic intervals along the length of the tube in the cross direction to form individual pouches measuring 18 cm by 5 cm, each containing 26 grams of composition. The pouches were placed in a water bath maintained between about 21° C. and 32° C. and exposed first on one side then on the opposite side to ultraviolet radiation at an intensity of about 4.5 milliWatts/square centimeter for 8.3 minutes to cure the composition. The radiation was supplied from lamps having about 90% of the emissions between 300 and 400 nanometers (nm), and a peak emission at 351 nm. Copolymers were produced and evaluated for T_{g} and weight average molecular weights (M_{W}). The results are as summarized in Table 2. The resulting pouch adhesive was used to prepare pressure sensitive adhesive tapes of the invention using a hot melt process.

TABLE 2
Compositions of HTG and LTG Acrylic Copolymers

| | IOA | BA | IBOA | AA | IRG651 | IOTG | DAR1173 | Mw | T_{g} |
|---|---|---|---|---|---|---|---|---|---|
| Polymers | (pbw) | (pbw) | (pbw) | (pbw) | (pph) | (pph) | (pph) | (g/mol) | (° C.) |
| HTG-1 | 0.00 | 0.00 | 97.00 | 3.00 | 0.00 | 0.75 | 0.15 | 35,000 | 94 |
| LTG-1 | 45.00 | 45.00 | 0.00 | 10.00 | 0.15 | 0.06 | 0.00 | 800,000 | −43 |

### Preparation of Composition Example E1

The Composition Example E1 was prepared using the composition shown in Table 3 (below). All amounts shown are given in parts by weight (pbw). The materials were compounded using a co-rotating twin screw mixer and subjected to 300 rotations per minute mixing (rpm) for five minutes. The mixer temperature was set to 193 degrees Celsius.

### Preparation of Composition Example E2-E7

The preparation of Composition Example E1 was repeated with the following modifications. The Compositions Examples E2-E7 were prepared using the compositions shown in Table 3.

### Preparation of Comparative Composition Example C1

The preparation of Composition Example E1 was repeated with the following modifications. The Comparative Composition Example C1 was prepared using the compositions shown in Table 3.

### Preparation of PSA Tape Examples T1

To prepare the PSA Tape Example T1, the Compositions Example E1 was melt-pumped from the twin screw extruder via gear pump and hose through a slot die set to a temperature of 204 degrees Celsius. The pressure sensitive adhesive composition was cast onto the high release force side of RELEASE LINER 1 to form a PSA tape of approximately 75 micrometers thick. The low release force side of a second piece of RELEASE LINER 1 was then laminated to the exposed adhesive surface of the PSA tape. The PSA tape between two release liners was chemically crosslinked by an electron beam processing unit (ELECTROCURTAIN CB-300 from Energy Sciences Incorporated, Wilmington, Mass.) at an accelerating voltage of 270 Kiloelectron Volts (KeV) to provide a dosage of 5 megarads. The crosslinked PSA Example T1 was then evaluated for Peel Adhesion to Polycarbonate and Static Shear Adhesion to Polycarbonate as described in the test methods above. The results are as summarized in Table 4 below.

### Preparation of PSA Tape Examples T2-T6

PSA Tape Example T1 was repeated with the following modifications. The PSA Tape Examples were prepared using the pressure sensitive adhesive compositions and electron beam doses shown in Table 4. The PSA Tape Examples were then evaluated for Peel Adhesion to Polycarbonate and Static Shear Adhesion to Polycarbonate as described in the test methods above.

The results are summarized in Table 4 below.

### Preparation of PSA Tape Comparative Examples CT1-CT3

The preparation of PSA Tape Example T1 was repeated with the following modifications. The PSA Tape Comparative Examples were prepared using the pressure sensitive adhesive compositions shown in Table 4. The PSA Tape Comparative Examples were not chemically crosslinked by electron beam radiation. The PSA Tape Comparative Examples CT1-CT3 were then evaluated for Static Shear to Polycarbonate as described in the test method above. The results are summarized in Table 4 below.

### Preparation of PSA Tape Examples T7-T10 and Comparative Tape Examples CT4-CT8

PSA Tape Example T1 was repeated with the following modifications. The PSA Tape Examples were prepared between the treated surface of PET 1 and the release surface of either RELEASE LINER 2 or RELEASE LINER 3 as specified in Table 5 below. The pressure sensitive adhesive compositions and electron beam doses used are shown in Table 5 below. The PSA Tape Examples were then evaluated for Liner Release as described in the test method above. The results are summarized in Table 5 below.

### Preparation of PSA Foam Tape Example T11

A foam sheet was prepared in the same way as the foam sheet prepared in Example 4 of U.S. Pat. No. 6,103,152, incorporated in its entirety herein by reference, except the hot melt pressure sensitive adhesive composition was 95 parts of 2EHA and 5 parts AA and the foam sheet was extruded onto the high release side of RELEASE LINER 1. The foam sheet Foam Density was 600 Kg/m³. The Composition Example E1 was melt pumped from the twin screw extruder via gear pump and hose through a slot die set to a temperature of 204 degrees Celsius. The pressure sensitive adhesive composition was cast onto the high release force side of RELEASE LINER 1 to form a PSA tape of approximately 75 micrometers thick. The PSA tape was then laminated to the first and second side of the foam sheet using a PA1-B Hand Applicator Squeegee obtained from 3M Company, St. Paul, where the RELEASE LINER 1 was removed from the foam sheet after the application of the PSA to the first side of the foam sheet and before the application of the PSA to the second side of the foam sheet. The application of the PSA to the foam sheet was done in such a way that no visible air pockets or bubbles where entrapped between the PSA and the foam sheet. The result was a three-layered pressure sensitive adhesive foam tape construction of the PSA on the first and second side of the acrylic foam sheet and positioned between the high and low release surfaces of two sheets of RELEASE LINER 1. In order to assure an intimate bond between the PSA and the foam sheet, the pressure sensitive adhesive foam tape with release liners was placed on a flat work bench and exposed on each side to 1-2 seconds of heat from a hot iron, obtained from Maytag model E354804. The surface of the heated iron was 107 degrees Celsius as measured by a contact thermal meter obtained from Anritsu Meter Company, Tokyo Japan. The pressure sensitive adhesive foam tape with release liners was then chemically crosslinked by passing two times through an electron beam processing unit (ELECTROCURTAIN CB-300 from Energy Sciences Incorporated, Wilmington, Mass.). Each pass through the electron beam unit was at an accelerating voltage of 300 Kiloelectron Volts (KeV) and a dosage of 6 megarads. The foam sheet with release liners was turned over between passes.

### Preparation of PSA Foam Tape Examples T8-T22

The preparation of PSA Foam Tape Example T8 was repeated with the following modifications. The PSA Foam Tape Examples were prepared using the pressure sensitive adhesive compositions and electron beam doses shown in Table 6.

### Preparation of Comparative PSA Foam Tape Examples CT9-CT10

The preparation of Foam Tape Example T8 was repeated with the following modifications. The Comparative Foam Tape Examples CT9 and CT10 were prepared using the pressure sensitive adhesive compositions and electron beam doses shown in Table 6.

| PSA | | | | | | | | SA90 | LTG-1 | IRG | |
|---|---|---|---|---|---|---|---|---|---|---|---|
| Composition | D1161 | D1118 | PASBC | HTG-1 | E5340 | P125 | P140 | (PPE) | Acrylic | 1010 | EVA-CB |
| Example | (pbw) | (pbw) | (pbw) | (pbw) | (pbw) | (pbw) | (pbw) | (pbw) | (pbw) | (pbw) | (pbw) |
| C1 | 38.60 | 13.70 | 8.30 | 0.00 | 34.50 | 0.00 | 0.00 | 0.00 | 3.30 | 1.10 | 0.40 |
| E1 | 34.60 | 12.70 | 7.50 | 5.80 | 31.20 | 0.00 | 0.00 | 3.80 | 3.00 | 1.00 | 0.40 |
| E2 | 44.60 | 9.70 | 8.60 | 4.40 | 25.20 | 0.00 | 0.00 | 2.50 | 3.50 | 1.10 | 0.40 |
| E3 | 26.90 | 15.00 | 6.70 | 6.80 | 35.90 | 0.00 | 0.00 | 4.90 | 2.70 | 0.90 | 0.30 |
| E4 | 39.20 | 5.40 | 7.10 | 7.30 | 0.00 | 29.50 | 0.00 | 7.30 | 2.80 | 0.90 | 0.40 |
| E5 | 34.90 | 12.40 | 7.50 | 5.80 | 0.00 | 15.60 | 15.60 | 3.80 | 3.00 | 1.00 | 0.40 |
| E6 | 42.44 | 12.36 | 0.00 | 5.75 | 31.23 | 0.00 | 0.00 | 3.84 | 3.01 | 1.00 | 0.40 |
| E7 | 35.68 | 13.05 | 7.77 | 5.93 | 32.20 | 0.00 | 0.00 | 3.95 | 0.00 | 1.00 | 0.40 |

TABLE 4
PC Peel and Shear Adhesion Results of PSA
Tape Examples and PSA Tape Comparative

| | | | 70° C. | 105° C. | |
|---|---|---|---|---|---|
| | | | Static | Static | |
| | | Electron | Shear | Shear | Peel |
| PSA | PSA | Beam | Adhesion | Adhesion | Adhesion |
| Tape | Composition | Dose | to PC | to PC | to PC |
| Example | on Example | (megarads) | (minutes) | (minutes) | (N/cm) |
| T1 | E1 | 5 | 10000 | 10000 | 92.1 |
| T2 | E2 | 5 | 10000 | 10000 | 85.9 |
| T3 | E3 | 5 | 10000 | 10000 | 82.5 |
| T4 | E1 | 10 | 10000 | 10000 | 85.9 |
| T5 | E2 | 10 | 10000 | 10000 | 78.0 |
| T6 | E3 | 10 | 10000 | 10000 | 69.5 |
| CT1 | E1 | 0 | 138 | NT | NT |
| CT2 | E2 | 0 | 104 | NT | NT |
| CT3 | E3 | 0 | 102 | NT | NT |

*NT = Not Tested

TABLE 5
Liner Release Results for PSA Tape Examples
and PSA Tape Comparative Examples

| | | | RELEASE | RELEASE |
|---|---|---|---|---|
| | | Electron | LINER 2 | LINER 3 |
| PSA | PSA | Beam | Liner | Liner |
| Tape | Composition | Dose | Release | Release |
| Example | on Example | (megarads) | (g/cm) | (g/cm) |
| CT4 | C1 | 0 | 3.1 | 4.4 |
| CT5 | E1 | 0 | 2.7 | NT |
| CT6 | E3 | 0 | 1.8 | 3.4 |
| CT7 | C1 | 5 | 314.1 | NT |
| T7 | E1 | 5 | 39.4 | NT |
| T8 | E3 | 5 | 8.1 | 9.7 |
| CT8 | C1 | 15 | 897.2 | 795.8 |
| T9 | E1 | 15 | 637.8 | 703.1 |
| T10 | E3 | 15 | 70.6 | 107.7 |

TABLE 6
Initial Cold Peel Adhesion to PC and Static T-Block Tensile Adhesion
to PC Results of PSA Foam Tape Examples and Comparatives

| | | | | Static |
|---|---|---|---|---|
| | | | Initial | T-Block |
| PSA | | Electron | Cold Peel | Tensile |
| Foam | PSA | Beam | Adhesion | Adhesion |
| Tape | Composition | Dose | to PC | to PC |
| Example | Example | (megarads) | (N/cm) | (minutes) |
| CT9 | C1 | 6 | 20.9 | 1462 |
| T11 | E1 | 6 | 11.6 | 3692 |
| T12 | E2 | 6 | 22.6 | 2104 |
| T13 | E3 | 6 | 6.7 | >10000 |
| T14 | E6 | 6 | 11.7 | 2932 |
| T15 | E7 | 6 | NT | 5628 |
| CT10 | C1 | 12 | 16.7 | 6645 |
| T16 | E1 | 12 | 8.4 | >10000 |
| T17 | E2 | 12 | 13.6 | >10000 |
| T18 | E3 | 12 | 6.2 | >10000 |
| T19 | E4 | 12 | NT | >10000 |
| T20 | E5 | 12 | 7.9 | >10000 |
| T21 | E6 | 12 | 10.2 | >10000 |
| T22 | E7 | 12 | NT | >10000 |

TABLE 7
T_{g} Values

| Homopolymer | Tg (° K) |
|---|---|
| Acrylic Acid | 378 |
| Butyl Acrylate | 219 |
| 2-Ethyl Hexyl Acrylate (2EHA) | 223 |
| Isobornyl Acrylate (IBOA) | 367 |
| Isooctyl Acrylate (IOA) | 223 |
| N,N-Dimethyl Acrylamide (NNDMA) | 362 |

### Results

PSA Tape Examples T1-T6 exhibit high Peel Adhesion to Polycarbonate (PC) at 21 degrees Celsius and maintain Static Shear Adhesion to Polycarbonate of greater than 10,000 minutes at the high temperatures of 70 degrees Celsius, and at an even higher temperature of 105 degrees Celsius. The Comparative PSA Tape Examples CT1-CT3, where there is no electron beam crosslinking, all show poor Static Shear Adhesion to Polycarbonate at 70 degrees Celsius, all failing in less than 140 minutes.

Table 5 show the results of the PSA Tape Examples T7-T11 tested for Liner Release which exhibit a much lower test value than the Comparative PSA Tape Examples CT7-CT8, using the conventional (non-PPE) end block tackifiers with absence of HTG at both the 5 and 15 megarads electron beam doses. Further, the Table 5 shows the increase in the Liner Release when crosslinked with increasing dose from 0, 5 to 15 megarad electron beam radiation. This data demonstrates the need to minimize the electron beam dose in order to minimize Liner Release.

The PSA Foam Tape Examples T11-T22 exhibit excellent adhesion performance at extreme temperature conditions of 5 and 105 degrees Celsius, as measured by the Initial Cold Peel Adhesion to Polycarbonate and Static T-Block Tensile Adhesion to Polycarbonate. In the Comparative PSA Foam Tape Example, using the conventional (non-PPE) end block tackifiers with absence of HTG, result in lower Static T-Block Tensile Adhesion to Polycarbonate at 105 degrees Celsius at both the 6 and 12 megarad electron beam doses. The compositions allow for designing a PSA Foam Tape using lower electron beam doses while maintaining a balance of broad temperature performance as defined by Initial Cold Peel Adhesion to Polycarbonate Test of greater than or equal to 6 N/cm and Static T-Block Tensile Adhesion to Polycarbonate Test of greater than or equal to 2,000 minutes, or optionally, greater than or equal to 10,000 minutes. The desire to obtain the balance of broad temperature performance at an electron beam dose as low as possible is driven by the desire to maintain efficient and low-cost processing and to minimize damage to substrates and release liners from the electron beam radiation and that are a part of the pressure sensitive adhesive tape or pressure sensitive adhesive foam tape constructions.

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given to enable one of ordinary skill in the art to practice the claimed disclosure, is not to be construed as limiting the scope of the disclosure, which is defined by the claims and all equivalents thereto.

1. A pressure sensitive adhesive tape comprising;
a pressure sensitive adhesive layer having first and second opposed major surfaces, the pressure sensitive adhesive comprising:
a block copolymer component comprising a midblock segment and a plurality of end block segments, each end block segment comprising polystyrene;
a (meth)acrylic functional additive having a glass transition temperature of from 50° C. to 160° C.;
a first tackifier compatible with the midblock segment and comprising a hydrocarbon; and
a second tackifier compatible with the end block segments and comprising a polyphenylene ether;
wherein the pressure sensitive adhesive layer has been crosslinked by electron beam radiation.

2. The pressure sensitive adhesive tape of claim 1, wherein the electron beam radiation dose is between 2 and 24 megarads.

3. The pressure sensitive adhesive tape of claim 2, wherein the electron beam radiation dose is between 2 and 15 megarads.

4. The pressure sensitive adhesive tape of claim 1, wherein the first tackifier has a softening point temperature of from 80° C. to 160° C.

5. The pressure sensitive adhesive tape of claim 1, wherein the first tackifier has a glass transition temperature of 125° C. to 160° C.

6. The pressure sensitive adhesive tape of claim 1, wherein the second tackifier has a softening point temperature of from 100° C. to 230° C.

7. The pressure sensitive adhesive tape of claim 1, wherein the polyphenylene ether has a number average molecular weight of from 300 g/mol to 50,000 g/mol.

8. The pressure sensitive adhesive tape of claim 1, wherein the (meth)acrylic functional additive has a weight average molecular weight of from 1000 g/mol to 300,000 g/mol.

9. The pressure sensitive adhesive tape of claim 1, wherein the block copolymer component comprises a mixture of two of more of styrenic diblock, styrenic triblock, and styrenic star block copolymers.

10. The pressure sensitive adhesive tape of claim 1, wherein the (meth)acrylic functional additive is a first (meth)acrylic functional additive and further comprising a second (meth)acrylic functional additive having a glass transition temperature of from −60° C. to 25° C.

11. The pressure sensitive adhesive tape of claim 1, wherein the second (meth)acrylic functional additive has a weight average molecular weight of from 200,000 g/mol to 1,500,000 g/mol.

12. The pressure sensitive adhesive tape of claim 1, wherein the pressure sensitive adhesive is foamed.

13. The pressure sensitive adhesive tape of claim 1, further comprising:
a flexible backing disposed adjacent the first major surface of the pressure sensitive adhesive layer.

14. The pressure sensitive adhesive tape of claim 12, wherein the flexible backing comprises a plurality of layers.

15. The pressure sensitive adhesive tape of claim 12, further comprising:
a release liner disposed adjacent the second major surface of pressure sensitive adhesive layer.

16. The pressure sensitive adhesive tape of claim 1, wherein the flexible backing is foamed.

17. The pressure sensitive adhesive tape of claim 1, further comprising:
a release liner, and wherein the pressure sensitive adhesive layer is disposed on the release liner.

18. The pressure sensitive adhesive tape of claim 17, further comprising a liner release layer disposed on a major surface of the release liner, and wherein the pressure sensitive adhesive layer and the release liner sandwich the liner release layer, and wherein release liner, when separated from the pressure sensitive adhesive layer according to the Liner Release Test, yields a value of less than or equal to 100 grams/cm.

19. A pressure sensitive adhesive tape of claim 1, wherein the tape, when subjected to the Initial Cold Peel Adhesion to Polycarbonate Test results in a value greater than or equal to 6 N/cm.

20. A pressure sensitive adhesive tape of claim 1, wherein the tape, when subjected to the Static T-Block Tensile Adhesion to Polycarbonate Test results in a value greater than or equal to 2,000 minutes.

21. A method for making a pressure sensitive adhesive tape of claim 1, comprising:
disposing a pressure sensitive adhesive layer on a flexible backing, wherein the pressure sensitive adhesive layer comprises a pressure sensitive adhesive comprising:
a block copolymer component comprising a midblock segment and a plurality of end block segments, each end block segment comprising polystyrene;
a (meth)acrylic functional additive having a glass transition temperature of from 50° C. to 160° C.;
a first tackifier compatible with the midblock segment and comprising a hydrocarbon; and
a second tackifier compatible with the end block segments and comprising a polyphenylene ether;
crosslinking the pressure sensitive adhesive layer with between 2 and 24 megarads of electron beam radiation.
